(19) United States
(12) Patent Application Publication
(10) Pub. No.: US 2025/0314523 A1
(43) Pub. Date: Oct. 9, 2025

(54) SYSTEM AND AUTOMATION METHOD FOR RESTAURANTS, MONITORING AND WEIGHING DEVICE FOR RESTAURANTS, METHOD AND DEVICE TO ORDER FOOD FOR RESTAURANT

(71) Applicant: ZHTECH TECHNOLOGY SOLUTIONS LTDA, Penha-SC (BR)

(72) Inventor: Helmar ALVARES, Rio de Janeiro (BR)

(73) Assignee: ZHTECH TECHNOLOGY SOLUTIONS LTDA, Penha-SC (BR)

(21) Appl. No.: 18/865,633

(22) PCT Filed: May 11, 2023
(86) PCT No.: PCT/BR2023/050144

§ 371 Date: Nov. 13, 2024

(30) Foreign Application Priority Data
May 13, 2022 (BR) 1020220094080

(51) Int. Cl. G01G 19/414; G06F 3/0482; G06F 16/907

(52) U.S. Cl. CPC G01G 19/4146; G01G 19/4144; G06F 3/0482; G06F 16/907

(57) ABSTRACT

The present invention introduces a restaurant automation system that includes food ordering devices (1) and small IoT devices (30) for streamlined operations. Customers can use the device (1) to not only select food based on price but also specify the desired weight. Prior to ordering, customers can view allergen information, calorie/nutrient values, and dynamic colored graphs indicating whether the chosen foods align with their nutritional requirements. Each food item served on the customer's plate (41) is meticulously identified and classified, providing detailed information such as weight, ingredients, allergens, nutrients, expiration date, and origin. Orders are scheduled and processed through the device (1), allowing customers to create custom dishes according to their preferences. Custom Food Orders (OP) are recorded in the restaurant database, with food delivery services coordinated by the IoT device (30) located in the kitchen. This device guides employees in assembling the ordered food.

The present invention refers to a system and method of automation for restaurants, monitoring and weighing device for restaurants, method and device to order food to restaurant, with identification and classification of food served on the customer's plate.

More particularly, the system comprises: devices (1) to order food and small IoT devices (30), which are distributed for automation and control of restaurant delivery gourmet, self-service or à la carte.

The customer uses the device (1) to order their food not only for the price of the selected foods, but also for their weight.

At the time of ordering, the customer visualizes the allergens, and the values of total amounts of calories/nutrients, dynamic-colored graphs that objectively shows the value of these quantities, indicating to the customer, before ordering, whether the nutritional limits of the chosen foods are suitable for their consumption, according to the food needs defined by the customer himself for his meal.

In this way, each food served on the customer's plate (41) is identified and classified in detailed information of its content, such as: weight, ingredients, allergens, nutrients (cholesterol, sugar, calories, carbohydrates, etc.), expiration date, origin, etc.

Thus, orders are scheduled and/or made through the device (1) according to the customer's food selection and need, which allows the customer to assemble their own custom-made dish.

A custom Food Order (OP) is created, and is subsequently recorded in the restaurant database, ordering food delivery services for the restaurant. This order (OP) is received by one of the IoT device (30), localized in the restaurant's kitchen, which will guide the employee in assembling all the ingredients of the food ordered by the customer.

### STATE OF THE ART

Recently, due to time constraints and the need for social distancing, there is an increasing number of people looking for restaurant services with food delivery near their homes or their jobs. At the same time, awareness and interest in healthier eating is increasing.

To increase the convenience of people's lives, systems have been developed to ordering food that use mobile devices with applications with various functions installed on these devices, allowing customers to order food more accurately and diversity than conventional orders made by phone.

Most of these systems include devices for receiving food information and to send costumer's orders to devices located in the restaurant kitchen. For example, the system revealed in the document “Sanyo Electric Co. LTD,” JP2004021537, entitled “Merchandise order management method, device and system”, which reveals a system for ordering lunch (dishes of the day), comprising an order terminal (28) for ordering food, a server (22) for Daily food management, and an order receiver device (24), installed on a food manufacturing base.

Another example of these systems is revealed in patent U.S. Pat. No. 6,880,750 entitled “Remote ordering device”, which reveals a device to place orders for a restaurant, comprising mobile phones and a receiving station to receive food orders of a restaurant menu, where the orders are received, to be attend through one display or a printing, in the commercial establishment (restaurant).

In general, Food ordering devices show menus offering a pre stablished menu with set up dishes (already assembled) or predefined servings of each food, such as those listed on a restaurant menu/meal menu, without allowing the customer to choose the exact amount of food for their need. This is because, normally, in the case of changing the amount of the food on the plate, the restaurant would have great difficulty in immediately establishing the correct selling price of a dish and the exact information, about the food, in the quantity requested, because the restaurant lacks tools and management methods to define the immediate value of this dish if the customer requested the change of its quantity.

Those food choice options, because they are limited to food combinations and portions previously established by the restaurant, can lead to inconvenience of excessive purchasing food, which can most often lead to undesirable food waste, resulting in excessive cost to the customer. In addition, in view of the dish already being assembled by the restaurant, the customer only has the option of choosing the food that would most closely approach their need, not allowing the customer to follow their diet, or for treatment of diseases such as diabetes, high cholesterol etc. or for disease prevention, through diet for weight loss or weight maintenance.

In view of this, customers with needs to follow a specific diet can't make a personalized choice of foods through the appropriate amount and immediate view of the total amounts of calories and nutrients of the foods chosen in their order, so that they could make up their food according to their need.

That is, current restaurants do not offer means that allow the customer to place a food order through their desirable quantity, with detailed, accurate and immediate information about the amount of food quantity chosen, which could improve the consumer experience when choosing food.

In addition, in known systems, order deliveries are displayed in terminal devices of the restaurant kitchen, such as computer terminals, or are printed in paper, thus causing problems in the organization of the restaurant, such as errors or failures in the handling of the orders, delays in the distribution of orders (delivery time) or sending the wrong order to the customer.

### BRIEF DESCRIPTION OF THE PRESENT INVENTION

To solve the problems pointed out above and improve the efficiency in the automation of restaurant orders, were developed: the system and automation method for restaurants, monitoring and weighing device for restaurants, method and device for ordering food for restaurant.

The automation system for restaurants, of the present invention, comprises: a NoSQL database for data storage, in the cloud, of the food supplier (restaurant, catering service and etc.); plates for food (41) identifiable by RFID(s) (42) arranged in the bottom (41a) of each plate (41); devices (1) to place orders, using the application (app) “Custom Made Food” (CMF) installed, stored and processed in it, for the customer to order custom food orders; at least one IOT Monitoring and Weighing device (DMP) (30) distributed in the restaurant kitchen; and a server (20) for providing restaurant services, such as: web server, for payment processing, updating and administration of information in the restaurant database and etc.

The cloud database is preferably a low latency RTDB (Real Time Data-base), where stored data is synchronized with devices (1) and DMP(s) devices (30), which when connected to the database, they share instances in order to automatically receive updates of the information recorded by the restaurant. An example of the RTDB database is the NoSQL database (not SQL) Firebase, which stores the data as JSON (JavaScript Object Notation) and synchronizes these, in real time, for each client (device) connected to the present invention.

Devices (1), server (20) and DMP devices (30) are connected to the internet over the Wi-Fi network (IEEE 802.11b/g/n and 802.15.4), where all these devices access the RTDB database platform. The restaurant uses this platform to meet customers' requests and thus perform the delivery services.

The information stored in the aforementioned RTDB, used by the automation system for restaurants of the present invention, comprises: the nutritional profile of the client (8a), which will allow the customer to have a personalized nutritional planning of their diet, wherein this information about the client is used by the system algorithms to calculate and make available to the same their dietary restrictions; information about food, which can be based on the Food Nutrition Composition Table, for example the table published by Brazilian IBGE, which also contains the identification codes of each food; the food menus offered by the restaurant, comprising a list of foods, wherein that list includes the price per base weight (100 grams) and the identification (by its own ID) of each food and its food contents, calories, and allergens; customer Orders (OP); information on plates (41) with IDs used by the restaurant (such as: tare, manufacturer, etc.); and other information related to restaurant administration, such as information on food consumption, food stock, shopping, payments, etc.

The use of RFID to identify the food plate (41) allows the restaurant to use plates from several manufacturers with different Tares, since the system identifies the Tare, or weight, of each plate (41) through its ID previously registered.

The device (1) of the present invention allows the order to be ordered through the exact weight of the chosen food, giving the customer the option to plan their diet before placing the order for the restaurant. This is because, when being determined the weight of the food, by the costumer, the device (1) calculates and shows: the price of the selected food; the total amounts of calories and nutrients of the food selected for the customer Order (OP), according to the weight ordered for each food; the limits set by the customer; the monitoring each calculated value; and the allergens of the chosen food, before placing the order. For example, the customer may view: the price calculated for the selected food quantity; the total price of foods selected for the OP; the allergens contained in the selected food; the total amount of each item of the nutritional composition of the food (for example: the amount of energy (cal), carbohydrates (g), fat (g), fiber (g), etc.), contained in the foods selected for the OP; the results of monitoring each item calculated, in relation to the consumption limits per meal registered by the client, visualized through color graphs; the origin of the food, etc.

The device (1) used in the system can be a smartphone, notebook, tablet or even a PC′, which has advanced features that can be extended through applications run by your operating system, simply called app (application).

The app (CMF) of the present invention, stored in the device's memory (1), is run by the internal processor of this device (1), causing it to access and retrieve records of the RTDB, to store in its memory information as: inventory of menus, calories, nutrients and ingredients, their compositions and properties of food, and data of the customer profile, in order to process in real time the dishes (food) contained in the restaurant menu.

In operational example form, the device (1) presents on its home screen a link for the customer to inform their registration through a graphical user interface GUI (1a). Thus, the client defines his login and password, delivery address, body biotype, food profile, as the amounts of nutrients recommended by the nutritionist (limit of calories and nutrients per meal), in addition to allergens harmful to their health etc.

After registration, the system validates and grants access to the customer, through their login, allowing access, in the first graphical interface GUI (1a), for selection of restaurants of the system and menus of the restaurant, where buttons for choosing food, dessert and beverage menus are presented, as well as information about the restaurant.

After selecting the restaurant, the device processor (1) frees access to the selection buttons, which will give you access to the menu of the selected restaurant.

The restaurant menus presented on the device (1) have configuration elements that include menus of food, desserts, and drinks.

The device (1), as provided in the present invention, allows the customer to have access to the menus, select food from each menu and order food for the order OP, through a GUI that informs data of the selected food, which allows the ordering of the food determining the weight of the food, and shows, in real time, the results of: the price calculation of the quantity of ordered food; the total price of the foods selected for the OP; the total amounts of calories and nutrients of the foods selected for the OP, as well as performs and shows the monitoring of the items calculated in relation to the limits per meal established in the client's register. This GUI initially, at the time of the selection of the first food, and before ordering the weight of the food, presents in totals information, the results of the calculations for the price, the calories and each item of the nutrients of the selected food, calculated in relation to the price and base weight for the food established by the restaurant (e.g., for 100 g).

The processor relates the information of the selected food with the limits per meal, defined by the customer, informing these data in the GUI of ordering the weight of the food, and if the customer has not informed his limits in his consumption profile, these will be replaced by limits previously defined by the nutritionist of the restaurant, registered in the RTDB.

When selecting each food, the device (1) processes the information and configures it, according to the user's selection, creating a custom OP that, at the end of the order, will be registered in the database, thus ordering a food ordering service.

The device (1), as in the present invention, allows the food ordering to include beverages and desserts, and be made based on: the evaluation for each dish (like); the price of the food, in addition to the calculated price information for the selected food; total price of the foods selected for the OP; the total amounts of calories and nutrients of the foods selected for the OP, and monitoring of them shown through color graphics; allergens and limits per meal. Since the food planning GUI also allows beverages and desserts to be ordered by their quantities, through the number of units.

As an alternative, the amount of dessert can be determined through its weight, similarly to the amount of food.

By clicking on one of the food menu buttons of the GUI (1a), the device processor (1) creates another GUI (1b) corresponding to the selected menu showing the food list with information about the composition of each food or ingredients (51) and their respective prices by base weight (54), which can be per 100 g, and can also display icon like (53) indicating the percentage of likes evaluation for each dish, in addition to the icon “tray” (50) for access to the OP, and indicator of the number “N” (59) of items selected for the OP, by the customer.

When selecting the food by clicking on the name of the food, the processor creates another GUI (1c) configured to show information about the food, such as: like icon (53), indicating the percentage of evaluation likes for each dish; icon “tray” (50) for opening the OP; “N” (59) that indicates the total number of items selected by the customer in the OP; element (68) to add the selected food to the OP; the name of the food chosen (25); food ingredients (51); numerical text box (55) for the customer to order the weight of the food; and field to show the result of calculating the price (56) of the food for the ordered weight. In addition to this information, the processor presents, in this GUI (1c), a field of total information (52), configured to show in real time the results of calculations: of the weight and total price of the foods selected in the OP; total amounts for each item of food content, such as: calories, and nutrients (e.g.: sugars, sodium, carbohydrates, proteins, fats, etc.); the limits (43) of consumption per meal for each of these items, according to previous registration made by the client; and notification whether or not there are allergens (60) in the food. The GUI (1c) is exemplified in FIGS. 02 and 03.

The ordering by weight causes the nutritional totals of the food (52) are calculated proportionally by the nutritional information of the base weight (100 grams) recorded in the system (10c), indexed by the weight ordered by the customer in the numerical text box (55).

In the total information field (52), the device processor (1) also displays next to the calculation results, colored bar graph (67), with progressive color grading, for example: green, yellow, orange, and red.

Each graph (67) indicates, in real time, the result of monitoring each calculated item, based on the limits per meal (43), which are defined according to the customer's registration information (8a), recorded in their account in the RTDB.

By the addition of food (55), each bar chart (67) indicates an increase in the amount of food content. In this way, the customer can verify that the choice of food and the ordered weight (55) are within the limits (43) of their diet. In other words, the customer can check whether calories and nutrients are within the limits set for their daily needs per meal by reading the values of each food content (52) and the color of each graph (67), where the orange color indicates that the total quantity of the food content is at the limit and the red one (63) indicates that the amount exceeded this limit.

At the moment when the customer establishes the weight (55) in grams for the selected food (25) and verifies that the price and nutritional quantities are or are not within their limits per meal, the customer adds the food to the OP by triggering the link (68). This causes the device processor (1) to create the GUI (1d) to record the name of the food, its weight, and its price and perform the calculations of the total price of the food registered in this OP.

Case the customer wants to, he/she can change the weight of the food (55) what being selected in the GUI itself (1c). Also, there is the option to open the OP by clicking on the “tray” icon (50) and finalizing the order (1d) by pressing the “buy” button (57) or continuing to purchase another menu item by pressing the “continue buying” button (58), and yet can delete each item from the OP by triggering “Delete” buttons (66).

These settings presented by the device (1) allows the customer to configure/select the foods to perform the nutritional assembly of their meal, specifying the weight of each food chosen, in such a way as to make up their specific caloric/nutritional diet.

In this way, the selection of the food, with its defined weight, allows the device (1) to accurately inform, in real time, the total price, the total amounts of calories and nutrients of the foods selected for the customer's OP, guiding the customer at the time of the assembly of the OP, since the device (1), with the CMF app, shows the total amounts of nutrients and indicates by colors (67) if they are close or exceeded their daily limits per meal, if there are allergens in the food, or if there is another food restriction, as previously made by the client, improving the level of satisfaction of users interested in food and health.

Similarly, by clicking on one of the dessert or beverage menu buttons in the menu GUI (1a), the device processor (1) creates a GUI (1b), corresponding to the selected option, showing the restaurant menu through a list of desserts or drinks, prices and like icon (53) with their percentage.

When selecting the dessert, or beverage, by clicking on a item related on the menu list, the processor creates a GUI (1c) configured to display: the information about the dessert, or beverage, selected; a numeric text box (55) for the customer to order the amount of dessert, or beverage, and the total information (52) about the foods selected in the OP. The field with the total information (52) will show: the weight and total price of the foods selected in the OP; the total nutritional amounts of each item of food content (such as: calories, nutrients, allergens) of the foods selected by the customer; whether or not there are allergens; the consumption limits per meal for each of these items, according to the previous registration made by the client and the colored graphs (67) of monitoring the calculated items.

Both in the case of choice of dessert and in the choice of beverage, the device processor (1) performs the following operations: checks the price of the chosen item, and information registered in the RTDB; calculates the price of the item based on the quantity of items and information recorded in the database; checks the quantities of food content (e.g. calories, sugars, sodium, carbohydrates, etc.) of the chosen item; calculates the quantities of the total food content; monitors each of the quantities of total food content, in relation to the limit values (43) registered by the customer; and shows, in real time, in the field of total information (52) of the GUI (1c) to order dessert/beverage: the price of the food (dessert or beverage) selected; the total weight of the selected foods of the OP; the total price of selected foods (food, beverage/dessert) of the OP; the results of calculations of each amount of total nutritional content of the food selected from the OP, including the amounts of calories and nutrients of the selected food; the generated color charts, showing the results of monitoring each calculated item, where the price, quantity and name data of the selected food, are sent to add the food to the OP after the customer clicks/triggers the link (68). These procedures are performed for each selected food.

As the GUI (1c) of selection/ordering of food, the GUI (1c) for the selection/ordering of desserts or beverages is configured to show the graphs resulting from the monitoring of the total amounts of calories and nutritional contents, the price and total weight, with the progressive graduation of colors, dynamically demonstrating the increase in the amount of food content, where the color orange indicates that the quantity of the food content is at the limit and the red color indicates that the said quantity exceeded the limit established by the customer, as described in his food profile, previously registered.

As seen, the CMF app of the present invention, installed on the device (1), allows the customer to configure their order based not only on the prices of selected foods, but also on accurate information for monitoring their diet, which provides graphic alerts for the customer's food limits, based on the reports of their registration or on the recommendation of a nutritionist of the restaurant.

As alternatives, the device (1), with the CMF app of the present invention, can also carry out the custom order through the amount of Calories or Total Carbohydrates of the foods selected by the customer in the OP.

Payment can be made through payment process based on various online payment methods, such as: credit card, debit and/or Bank transfer (PIX—Brazilian specific payment method) etc.

After payment, a message (SMS, Whatsapp or e-mail) is sent to the customer with the order number and the description of the chosen food, so that the customer can track the progress of the order.

When the payment is made, the system confirms the customer's OP and includes it in a Orders List (LOP) in the RTDB, to be serviced by the first Monitoring and Weighing IoT Device DMP (30) of the restaurant that has the status “idle”.

In case DMP is used in the restaurant kitchen, it is connected to the database by sharing an instance of RTDB and thus receives the list LOP (9a) from the restaurant, that has all OP(s) (9b) of customers who have not been served. In the kitchen, the DMP that has “idle” status, displays a message on its display informing the kitchen employee that it is “waiting for a new order”. The “idle” DMP looks for the first OP (9b) available to be met, through the information “acceptance date” null (9e) in the list LOP (9a).

When identifying an OP (9b) not met in the LOP (9a), the microcontroller (31) makes an update on this OP, stored in the RTDB, with the information of its ID (factory unique identification) (9g) and “acceptance date” with the date and time of the system (9e). Thus, the RTDB communicates to the other “idle” DMP(s) of the restaurant, that share the same instance, that there is a “suitor” for the execution of the order, identified by the factory identification of the DMP “applicant”.

The other “idle” DMP(s), also located in the kitchen, will be informed of this change in the OP (9e; 9g) by the asynchronous “callback” function existing in each DMP and sharing the same instance of RTDB. That is, any change in the LOP (9a) of the RTDB, will be communicated to all DMP(s) of the kitchen by this “callback” function.

To avoid competition in communication between “idle” DMP(s), each DMP “applicant” draw a random time to send its identification information (9g) and date (9e), where consequently what to report in the shortest random time will be the “suitor” of the EXECUTION of the OP (9b).

If the identification of the “applicant” DMP is not confirmed, the microcontroller changes its status to “idle” and informs on its display that the “order has been cancelled”, returning to search in the LOP (9a) another unmet OP (9b) that has null “acceptance date” (9e).

The DMP (30) when confirming your factory ID (9f), after a certain waiting time, causes your status to be changed from “suitor” to “executor” and displays, on its display, a guidance message so that the restaurant kitchen employee “places an empty plate” on the scale of DMP, until the plate (41) is placed on the scale.

The kitchen employee places a plate (41), with RFID device (42) at its bottom, on the scale (38, 39) of the DMP (30). The RFID device ID (42) is automatically read by the RFID reader (32), located on the scale (38; 39; 37).

The microcontroller (31) relates the RFID ID of the plate (41) with the number of the OP (9b), thus identifying the Tare of the plate (41), the customer's ID (9f) and its dietary restrictions (8a), and the list of foods (9d)/dessert/beverages (9c) registered in the OP. For each food on the list, the microcontroller (31) builds information as: allergen, nutrients, and ingredients, in its main memory RAM, reading that information directly in the food collection (10a, 10b and 10c) stored in the RTDB, indexed by the id of each food.

Thus, the DMP (30) begins to guide the kitchen employee step by step through the DMP's display (33), to perform the assembly of the food ingredients on the plate(s) (41), as ordered by the client.

When starting the orientations on the display (33), the microcontroller (31) presents the first food item of the OP with its list of ingredients (46), which is arranged between two control/selection buttons, left (44) and right (45), to select the ingredient to be served. When selected, the ingredient to be served is indicated and highlighted by the microcontroller (31), through color, to facilitate the reading of the kitchen employee. At the time the ingredient is selected, the microcontroller calculates the weight limit (47) of the ingredient, showing its result on the display (33b).

The kitchen employee places on the plate (41) each selected ingredient item, from the list of food ingredients (46), highlighted by color, visually controlling the information presented on the display (33), mainly: the weight (64) of the ingredient, highlighted by the same color of the ingredient in the list (46); the total weight of the food (73), measured by the scale (30); and the graphs (67) corresponding to the items “Ingredient” and total weight (“Dish”) of the food (73), showing the monitoring weights in relation to their limit quantities.

At the moment the ingredient is placed on the plate (41), the microcontroller (31) performs the following operations: reads the weight of the plate (41), on the scale (30); calculates the weight of the food/ingredient (64) being placed on the plate (41), discounting the Tare (weight of an empty plate); checks whether the weight of the food placed on the plate (41) is equal to the weight of the food listed in the OP; calculates the price of food (49); calculates the quantities (65) of the food contents (e.g. sugars, sodium, calories, carbohydrates, etc.) of the food placed on the plate (41); adds the calculated weight to the total weight of the food on the plate (41); adds each calculated amount of food content to its corresponding total amount of food content; performs the monitoring of each item, calculated in relation to its limit values (43); generates bar chart (67) for each monitoring item; informs the allergens (48) of the food/ingredient; and shows this food information on the display (33). This information, shown on the display (33), refers to: weight of the ingredient (64) and its limit (47) calculated; weight of the food placed on the plate (41) and its ordered limit (55) in the OP; price of the food (49) and its limit established in the customer's register; total (65) of each food item and its limits (43), of consumption per meal; and allergen (48) of the food selected to be served, according to previous registration of the food informed by the restaurant.

In addition to this information, on display (33) are presented next to each calculated item (65), the corresponding colored bar charts (67) with the progressive graduation of colors, for example: green, yellow, orange and red, where each graph dynamically indicates the results of monitoring the weight of the ingredient (64), weight of food, price, calories, and each item of food content (nutrient), based on the list of foods/quantities described in the OP, the customer registration (8a), registered in their account in the RTDB and information of the ingredients and allergens registered by the restaurant (10a, 10b and 10c).

Thus, according to the increase in the amount of food on the plate (41), each bar chart (67) progressively changes its color to indicate the increase in weight (64) and the total quantities of the food content (65), allowing the employee to check the quantities of food placed on the plate (41), according to the customer's order, registered in the OP (9d and 9c). The colors of said graphics are gradually changed as the employee places the food on the plate (41), where the orange color indicates that the quantity of the food content is at the limit and the red one indicates that the said quantity exceeded the limit established by the customer.

After reaching the total weight of this ingredient (47), the employee manually triggers the right button (45) of control/selection of ingredient, to select the next element of the list of ingredients, where the microcontroller (31) will operate, performing calculations and monitoring for information about the food being served and computing the food already served. Following, at the end of each ingredient collect, the employee repeats the action of adding ingredient to the plate (41) and so on. Being able to return (44) to the previous ingredient of the list to make corrections, adding or removing the ingredient from the plate (41) in order to obey the customer's OP.

At the moment when the list of ingredients (46) of the food is fully scrolled, the microcontroller (31) records the food item, with its information, in an Electronic Command (FIG. 11) in the RTDB, and checks if there is another item in the food list OP. Then, the microcontroller (31) sends message to the display (33), guiding the kitchen employee to remove the plate (41) from the scale (38,39) and place another plate (41) on the scale, in order to begin the packaging of the next food item, if there is any other, in the OP.

After the new plate (41) is positioned on the scale (38; 39; 37), the microcontroller (31) repeats the steps of reading information described above and starts to show the next item in the list of foods and its ingredients, guiding the employee in the step by step for the assembly of the order, by the ordered selection of the items of food ingredients. Thus, the microcontroller (31) successively repeats the actions of: reading the information in the RTDB; calculating of the weight and price of each selected ingredient; calculating of the weight of the food in the plate (41); calculating of total amounts of calories and nutrients; monitoring and generating graphs and showing their results in the display (33). Repeating those actions until the end of the entire list of foods described in the OP.

For example, the OP's food item is composed by portions of ingredients: the microcontroller scrolls through the OP items and reads its first item “265 g of spaghetti Bolognese”. In this case, the microcontroller will read the information on ingredients/quantities of the dish “Spaghetti Bolognese” in the list of ingredients/basic quantities (100 g) of the Chef, registered in RTDB, as being composed of spaghetti type pasta, Bolognese sauce, and grated Parmesan cheese. Based on this list of basic ingredients/quantities, the microcontroller will calculate the quantities of each ingredient proportionally to the weight ordered in the OP. In this example, for “265 g of spaghetti Bolognese”, the microcontroller can obtain the result: 200 g of spaghetti-type dough; 60 g Bolognese sauce; and 5 g grated Parmesan cheese. After reading the information about the OP item, the microcontroller will show on the display the name of the dish “Spaghetti Bolognese” and its composition: spaghetti; Bolognese sauce, and Parmesan cheese. Then, the microcontroller will begin selecting the ingredient marking it with color, signaling the first item (spaghetti dough) to be placed on the plate (41). Then, it will show on the display the limit quantity (200 g) of the ingredient, according to calculation based on the ingredient list/quantities of RTDB, guiding the kitchen employee to put 200 g of spaghetti on the plate (41). When the employee places the spaghetti on the plate (41), the microcontroller performs, in real time, the calculations: weight of the ingredient, total weight of the food served; total price of food; the total amounts of calories and nutrients of the food served; the monitoring with respect to the limits of each calculated result; and it shows on the display the results of these calculations as well as their corresponding colored graphs, that show the monitoring of these results in relation to their limits, and also, shows the maximum limits of each calculated item and indicates whether the food has any allergenic.

Thus, the kitchen employee is instructed to place on the plate, in sequential order, the first ingredient of the OP food: 200 g of spaghetti dough, having guidance not only by the calculated weight of the ingredient, but as by the colored graph that indicates through its progressive colors, whether the weight to be reached is close to the maximum weight or not, orange or red. Thus, successively for the other ingredients. After the last ingredient is placed on the plate (41), the microcontroller sends the data from the OP food item for registration in an RTDB Electronic Command.

In this way, the DMP device, through its display, interacts with the kitchen employee to identify and select the food to be served on the customer's plate (41), thus following the detailed specification of each food (food, weight, calories, carbohydrate, sodium, etc.) made by the customer himself in the OP.

Alternatively, the DMP can perform the automatic control of the selection of the ingredient to be served on the plate (41), through its weight. In this case, the kitchen employee does not need to push the button right (45), to proceed with the selection. This is because, although the employee, when placing the ingredient on the plate (41), is based on the weight and color information of the monitoring bar chart (67) when reaching the limit weight of the ingredient, the microcontroller (31) automatically signals to inform the employee that it will proceed to the next ingredient. Instructing, thus, the kitchen employee to put each ingredient in the dish (41) according to its weight (47), which is calculated based on the list of ingredients/quantities pre-established by the Chef of the restaurant, proportionally to the weight ordered in the OP.

After all of OP's items have been placed on the plates (41), the microcontroller (31) records this information in an Electronic Command (FIG. 11), such as the information of the food served, with its price, weight, allergens, total ingredients and nutrients, and terminates the operation by presenting, on the DMP display (33), the message “Waiting for order”, returning to look for the available OP with “acceptance date” null, in the RTDB order list.

In case the customer does not inform their food profile to the system, the DMP uses the calorie limit etc. according to the average limits, guided by a nutritionist, registered in the RTDB by the restaurant.

In view of the guidance are made step by step, the DMP can be operated by any kitchen employee, allowing the assembly of the dishes to be done by an employee with no experience in cooking, but guided by the restaurant's Chef.

All guidance to the employee is made electronically, thus eliminating the need for the use of paper, which in addition to providing savings for the restaurant it is the better option for the environment.

Thus, the DMP (30) provides automated order fulfillment, through the direct redemption of the OP, registered in the list LOP of RTDB by the device (1), identifying the order by the customer's identification and by the identification of the plates/containers for delivery, and performing guidance for the assembly of the order, through the weight of food. In this way, the proposed system aims to solve the problem of errors or failures in the handling food orders, delays in the distribution of orders (delivery time) or wrong order shipping to the customer.

In addition, the system allows to optimize the control of food inventory, through information collected about the consumption preferences of its customers.

The System can also be used in the composition of dishes provided by catering services, for events or food on board, on by planes, trains and buses or other means of transport, where the customer based on the food list (menu) of the restaurant makes his personalized order selecting the foods by the weight and nutrients based on their dietary restrictions, previously registered.

Customers who prefer a full-service restaurant can make their orders on the system using their personal smartphones or tablets owned by the restaurant.

Over time, in the use of the system by the registered customer, the information registered in the RTDB will allow the customer to build their own personalized menu, which can be reused at any time. In addition, it also allows the customer to exchange their personalized menu with other customers of the restaurant system or on social networks.

The system also allows the customer to be part of customer loyalty program, through the restaurant app, allowing the customer to receive/redeem periodic reports with nutritional/dietary data of the food consumed.

### Objectives

allow the customer to make the personalized nutritional assembly of their meal, having full control of the nutritional contents of their meal, through the weight of each food chosen, in such a way that it accompanies their caloric and nutritional diet;
allow the client to control his diet without having to make calculations, since the device (1) calculates the total amounts of calories and nutrients of the selected foods and monitors them in relation to the limits informed by the client, showing through graphs the colored alerts for each food content;
allow the personalized nutritional assembly of the meal, based on the total amount of calories of meal;
allow the personalized nutritional assembly of the meal, based on the total amount of carbohydrates of meal;
allow the customer to control the excessive consumption of calories, sugars, fats and etc., in order to maintain a more efficient nutritional balance, aiming at positive results for their health, thus avoiding obesity, diabetes and other diseases;
allow the meal to be paid for the actual price of the chosen food, since the weight and price of each food are precisely recorded according to the food;
allow the order to be made by the weight of each food chosen, avoiding leftovers or food waste;
allow that the assembly service of the meals, ordered for the restaurant, can be made by an employee with no experience in cooking;
make the restaurant smarter, speeding up its service, where paper commands will no longer be needed;
make available to the client, in a personalized way, the historical nutritional information, through periodic nutritional and dietary reports;
improve the customer experience with a personalized treatment;
allow the restaurant administrator to manage his establishment more efficiently, through the information as cost, stock, staff, etc.;
allows to reduce delays in the distribution of orders and avoid sending wrong orders to the customer, controlling each order by its actual location, informed by reading its ID (RFID);
allow the restaurant to meet requests by weight in order to provide a unique gastronomic experience, with nutritional security, according to each client's food profile;
generate a geographical database of eating habits of the population using the system, respecting the current legislation on data protection, which can be used by industry or government entities in development oriented to the supply and production of food to specific populations, as well as in the long-term strategic planning of both production and logistic distribution of food;
the plates or containers of the restaurant may be supplied by several manufacturers, since the specification of the Tare of these will be related to the individual identification of the plate by its RFID;
allow a planning of the restaurant menu based on macro/micro factors with dynamic times with accurate calculations of the CMV.

As long as they are appropriate, the above settings and forms of development can be combined with each other as desired. Other possible configurations, forms of development and applications of the invention, also include combinations not explicitly mentioned of characteristics of the invention described earlier or below in relation to the execution examples.

### BRIEF DESCRIPTION OF DRAWINGS

The present invention is best viewed and indicated in an example, but not restrictive, by any way, through the drawings accompanying this application, in which:

FIG. 01—shows the block diagram of the automation system for restaurants according to the present invention;

FIG. 02—shows a diagram illustrating the graphical user interfaces (GUI), with information provided by the restaurant, exemplifying modes of choice of menus, food selection, OP and food profile of customer, according to the present invention;

FIG. 03—shows, in an enlarged way, the GUI to order the weight of the selected food, shown in FIG. 02, according to the present invention;

FIG. 04—shows, in an enlarged way, the GUI with the food profile of the registered customer, shown in FIG. 02, according to the present invention;

FIG. 05—shows the blocks diagram of the IOT Monitoring and Weighing Device (DMP) of the present invention;

FIG. 06—shows top view of the DMP, with the Scale, and touchscreen display showing graphic/numerical information of weight and total food content of the food placed on the plate (41), according to the present invention;

FIG. 07—shows the Flow chart of operation of the DMP, according to the present invention;

FIG. 08—shows an example of a record of the customer's registration information in the restaurant's RTDB, with its restrictions, as in the present invention;

FIG. 09—shows an example of a list LOP and its OP(s), with the list of foods, desserts and beverages, registered in the restaurant's RTDB, according to the present invention;

FIG. 10—shows an example of a record of information from one of the food from the restaurant menu, defining the allergens and ingredients of this food, registered in the RTDB, as in the present invention;

FIG. 11—shows an example of an Electronic Command registered in the RTDB, as in the present invention.

### DETAILED DESCRIPTION OF THE INVENTION

The following description will be made as a reference, only as an example of a preferred way of realization of the present invention, not being considered as a limiting form of: “SYSTEM AND AUTOMATION METHOD FOR RESTAURANTS, MONITORING AND WEIGHING DEVICE FOR RESTAURANTS, METHOD AND DEVICE TO ORDER FOOD FOR RESTAURANT”, as can be seen through the figures described below:

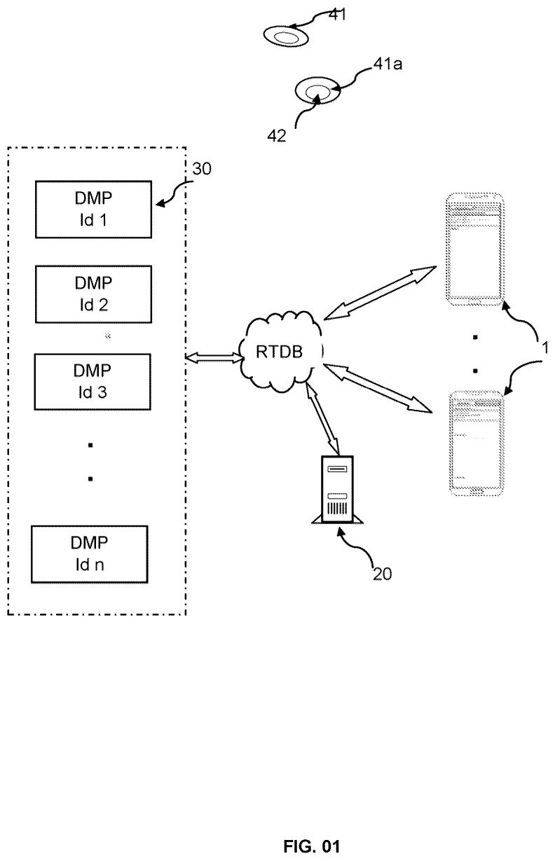

FIG. 01 shows the block diagram of the Automation System for Restaurant, wherein the system comprising: food plates (41) used by the restaurant, with RFID devices (42) arranged in its background (41a); at least one device (1) with the CMF app installed in its memory; and at least one Food Monitoring and Weighing (DMP) IOT Device (30), wherein said devices (1; 30) are connected to a decentralized cloud data storage platform (21).

The aforementioned platform is a low latency NoSQL (non-SQL) Real-Time Database (RTDB), such as Firebase, which stores the data in The JavaScript Object Notation (JSON) format and synchronizes this data by sharing instances between the database and the connected devices of the present invention.

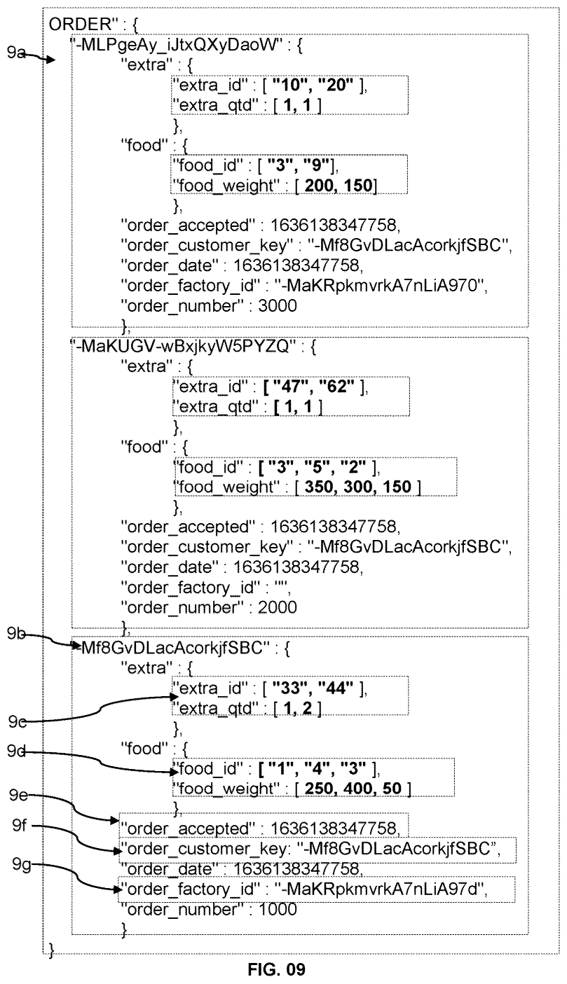

The devices (1) communicate with the RTDB so that the information of the restaurants of the network, and the menu of the chosen restaurant, are received, and the food is selected. Each device (1) generates order (OP) containing list of information of the selected foods, with identification, price and weight of each food, and later at the time of purchase, registers the OP in a list (LOP) in the RTDB database, which can be seen in FIG. 09. Subsequently, the DMP (30), from the restaurant kitchen, retrieves the order (OP), available for fulfillment, from the list of List of orders (LOP) of the RTDB, and guides in the fulfillment of orders through the weight of each food of the order in the OP.

In the system, shown in FIG. 01, is also forecasted a server for providing services (20) of the restaurant, used for the payment process, updating/administration of stored data and to enter new data in RTDB.

The device (1) is basically a device comprising: a control unit or CPU; a memory unit; a display or touch screen; input and output (I/O) devices, such as output unit and sound input; a camera unit; a wireless network communication module; a battery to provide power, where the CPU is connected to each function component through an internal bus of the device etc. By “Control Unit” or CPU, it can be understood that: they are the functional components that control the operation of the device (1) and includes at least one core processor and one main memory for the execution of the app.

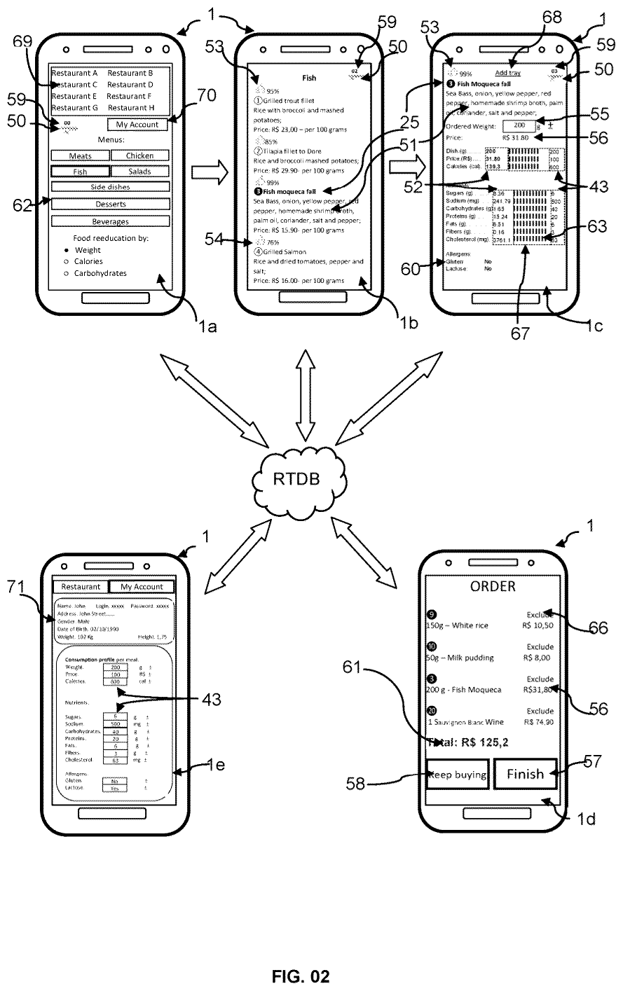

FIG. 02 shows a diagram illustrating an example of the operation of the device (1) of the present invention, with the app “Custom Made Food” (CMF) installed in its memory, where the customer will perform the selection of customized foods for his order.

As can be seen, FIG. 02 shows a GUI graphical interface (1a), which is initially created by the device processor (1), when the CMF is run, and is shown on the device screen (1). This GUI (1a) allows the customer to choose the restaurant (69) of their interest and create/access their personal account by clicking on “My Account” (70). By accessing this account, the customer will create his profile (71) by informing his data, such as: personal login and password; body biotype; name or pseudonym; delivery address; gender and date of birth; and consumption profile per meal (43), setting at this time the ideal limits of the nutrients, recommended by nutritionist, and allergens. After completing the registration and choice of the restaurant, the processor of device (1) will give access to the means (62) of GUI (1a), for selection of food menus of the selected restaurant in order to allow the selection of the food, beverages and desserts.

The menus, accessed through the GUI (1a), on the device's display (1), are obtained from the food lists of the chosen restaurant, registered in RTDB, and each food of these menus has records of calorie and nutrient information to allow the customer to select the food according to their convenience or nutritional need.

In the example of FIG. 02, the “Fish” menu option, of the GUI (1a), has been selected by touch, on the screen of device (1), causing the processor of device (1) to create another GUI (1b), where it displays: a “tray” icon (50) to access the OP; the number of items selected (59) of this OP; and the food list of the “Fish” menu, in which next to each item (25) of the list are shown their information of the composition of ingredients (51); the price (54) of each item (food) (25) calculated for 100 grams; and the indication (53) of the percentage “likes” with the evaluations of other customers who consumed the food in this restaurant.

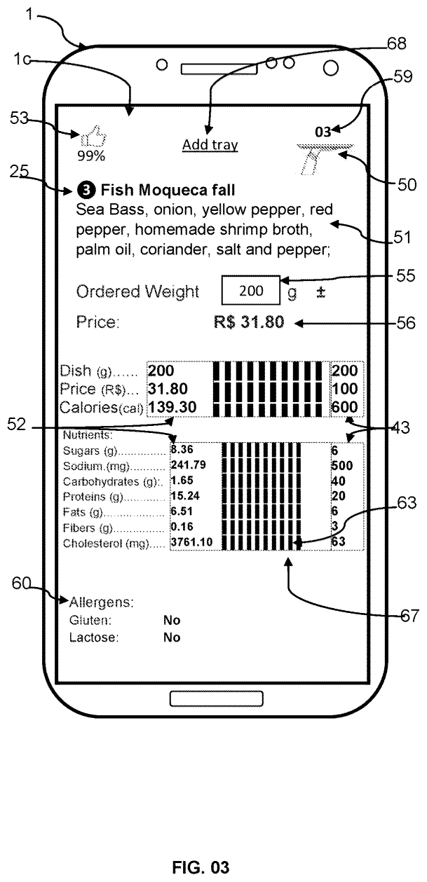

In the example shown in FIGS. 02 and 03, in GUI (1b), the dish or food “Fish Moqueca” was selected, whose description of its composition of ingredients is: “Sea bass, onion, yellow pepper, red pepper, homemade shrimp broth, palm oil, coriander, salt and pepper”, with a price of R$ 15.90 per 100 g; and indication (53) of which 99% of those who ordered and evaluated, liked that dish from the restaurant.

By clicking on “Fish Moqueca”, the device processor (1) creates another GUI (1c), in which they are shown: the “tray” icon (50) to access the OP; the indication (59) of the number of foods selected from the OP; the food code with the name of the food (25) selected; the set of information on the composition of food ingredients (51); a numerical dialog box (55) for the customer to order the weight of the food, in grams; the price (56) of the selected food, calculated on the basis of the base price for every 100 g; the results of the calculations (52) of total amounts of calories and nutrients of the foods already selected (listed in the OP); the limits (43): weight and price of food, consumption of calories and each nutrient, according to the customer's record; the colored graphs generated by the monitoring of each item calculated in relation to the limits (43), and allergen information (60), indicating whether or not the food has allergens, by the term “Yes” (in red) or “No” (in green). In the event that no food has not yet been placed to the OP, and also the weight for the food selected has not been determined, the information of the total amounts of calories and nutrients are the results of calculations and monitoring considering the price and base weight of each 100 g.

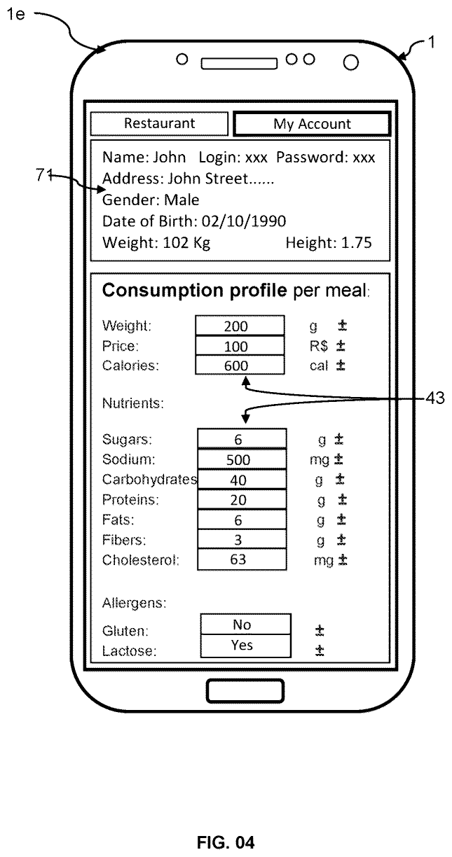

Also in the GUI (1c), shown in FIGS. 02 and 03, when the customer establishes the weight (55) of 200 g of food, the processor of device (1) performs the operations: calculation of the price of the food based on the price of R$ 15.90 per 100 g (base price established by the restaurant); calculations of the calories and nutrients of this food (Fish Moqueca); calculations of the total amounts of calories and nutrients of the foods selected in the OP, including the results of the calculations of their corresponding amounts of calories and nutrients of the selected food; monitoring of each calculation made in relation to the limit values (43) reported by the customer in his “Consumption Profile” (FIG. 4, 8a) per meal. Thus, as already described above, the information is processed, in real time, and shown in the GUI (1c), where each calculated item shown in the list (52) has a graph of colored bars (67) indicating its monitoring.

As can be seen in FIGS. 02 and 03, the customer can quickly check, through colors and total values demonstrated by the graphics (67) of the device (1), whether their order is in accordance with their diet.

In this example, the device processor (1) shows the alert for the total cholesterol amount (52) of the order, which is at 3,761.10 mg. This alert is visualized through the graph (67), which indicates in red (63), that this nutrient is far above the limit (43) “63 mg” of cholesterol, established by the client in his register (8a).

In the GUI (1c) allergens (60) “Gluten” and “Lactose” are also indicated, which in the case of the selected food, “Fish Moqueca”, are both indicated by the term “No” (in green).

Also in the GUI (1c), the customer adds the food to the OP by clicking on the link or “add to tray” button (68). This causes the device processor (1) to create a selected food data structure and register it in the OP, with the final data of the selected food (such as: food code, quantity, name, and price), calculating the total price of the account and opening the GUI (1d).

The GUI (1d) has buttons to “buy” (57), to “continue to buy” (58), and buttons (66) to “Delete” each OP's item and can be opened for conference by GUI (1a-1c), for corrections in the order and completion of purchase, through the touch activation of the “tray” (50).

The customer can go back to buying by triggering the “Continue buying” button (58), seen in the GUI (1d), so as to return to GUI (1a). In this way, the other menus are accessed, allowing to choose of more items, repeating the selection process by quantity or weight.

As can be seen in FIG. 02, the GUI (1d) has 4 selected items, and each of these food items are described by: its code, quantity, name and price, where: the first item, with code “9”, with an amount of “150 g, is “White rice”, and its price R$ 10.50; the second item, with code “10”, with an amount of “50 g”, is milk pudding, and price R$ 8.00; the third item, with code “3”, with an amount of “200 g”, is “Fish Moqueca”, and its price R$ 31.80; and the fourth item, with code “20”, with an amount of “1”, is “Sauvignon Blanc Wine”, and its price R$ 74.90; and the total price (61) of the OP is R$ 125.20.

When terminating your order, the customer clicks the “buy” button (57), and the device processor (1) directs the customer to the payment procedures, such as: cash, debit/credit card or PIX (in Brazil only).

The FIGS. 02 and 04 show the GUI (1e) of the device (1), exemplifying the customer's registration information, where the customer's food profile (43) will be established, informing limits for each meal, such as: of the weight, of price, of amount of calories and of each nutrient; the allergens; and personal information of the client, such as name, address and physical characteristics or their body biotype (weight, height, sex, date of birth, etc.). This registration can be done when the customer enters the system, under “My Account”, creating an “account/client” with login and password and, in this example, becomes a member/client of the personalized service of the system.

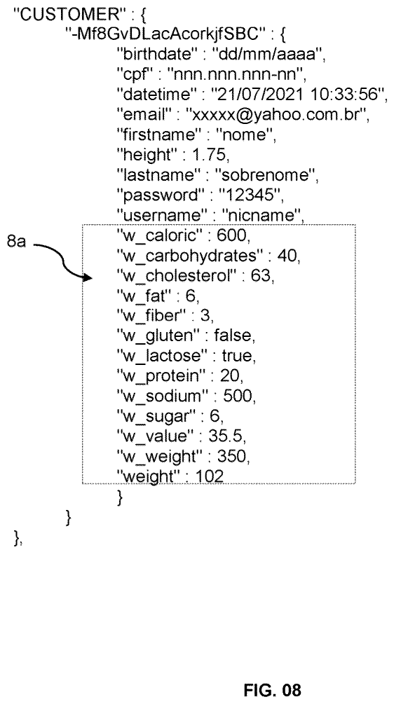

The customer when registering through the device (1) records the information in their account in the restaurant's RTDB, with restricted and secure access, so that they can log in and access, in real time, the records of their account. An example of a client record can be seen through the “JavaScript Object Notation” (JSON) framework presented in FIG. 08.

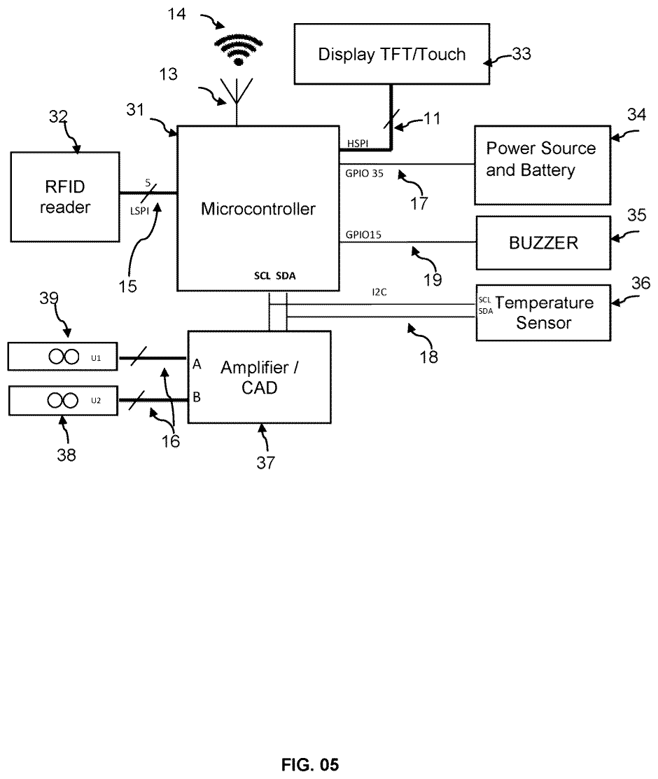

FIG. 05 shows the block diagram of the IOT Monitoring and Weighing (DMP) device (30) of the present invention, used in the restaurant kitchen, which is comprised of:
a microcontroller (31), which can be type “ESP32” or “Raspberry Pi”, which has connectivity to the router (14) Wi-Fi of the restaurant for access to the internet network;
a graphic display (33), touchscreen type (LCD TFT), for example, type ILI 9488, connected to the bus HSPI (11) of the microcontroller (31), to present images with guidance and information regarding the food of the customer's request to be served;
an RFID reader (32) connected to a serial interface LSPI (15) of the microcontroller (31), based on the chip “MFRC 522”, or preferably reader “PN 532”;
two load cells (38) and (39) connected to channels A and B (16) of an amplifier and digital analog converter (24-bit CAD) (37), e.g., “HX711” or preferably by “NAU7802” which is connected to the microcontroller (31) by communication of two of its I2C serial ports (18): SCL and SDA;
an antenna (13) for Wi-Fi, internal to the microcontroller (31), for receiving and sending data to the RTDB;
a temperature sensor (36) connected to the microcontroller (31), also by an I2C interface (18), to monitor room temperature and of the food, e.g., infrared temperature sensor MLX 90614;
an electrical power source (34), which may include a Li-Po-type renewable external battery, which powers the DMP (30) and is monitored by the microcontroller (31) by one of its programmable data input and output (GPIO) ports (17), programmed to use a 12-bit digital analog converter (CAD), in order to perform measurement and monitoring of the voltage level of that battery;
a buzzer device (35) connected to the microcontroller (31) by one of its GPIO ports (19), to emit sounds for signaling purposes.

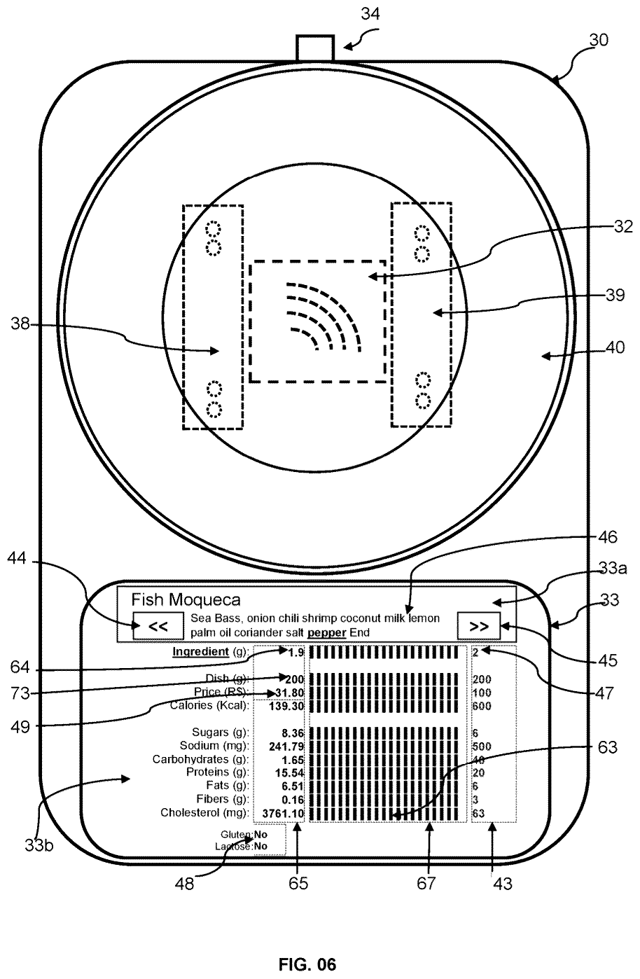

FIG. 06 shows a superior view of a way of performing the DMP of the present invention, where a circuit comprised of the devices (31, 32, 33, 34, 35, 36, 37, 38 and 39) of the DMP (30) is arranged in a small enclosure, which can be of resistant plastic.

In this FIG. 06, it can see the RFID reader (32) between the load cells (38, 39) under the plate (40) of the scale, the temperature sensor (34) and the display (33) showing the information of the food being served.

The display (33) presents a field (33a) for displaying each current food from the OP food list, to be collected. In this field (33a) are described: the name of the current food and the items of ingredients of its composition (46), arranged between the advance buttons (45) and return button (44), for selection and indication of the ingredient of the composition to be collected. When selected, the ingredient (46) is highlighted by color (red) in order to facilitate the reading by the employee. In addition, the display (33) shows a second field (33b) containing information, in real time, about the foods being served in the customer's plate (41), such as the results of calculations related to: weight (64) of the ingredient being served, which is also highlighted by the same color of the current ingredient described in the field (33a); the total weight (73) of the food served on the plate (41); the total price of food (49) served; the total amounts of calories and nutrients of the food (65) already served on the customer's plate; food allergens (48); the weight limit (47) of the ingredient being served, calculated proportionally to the weight of the food ordered in the OP, based on the restaurant's Chef's list of ingredients; the limits set by the customer in his consumption profile (43), per meal; and color bar charts (67) dynamically showing the results of monitoring of: the weight of the ingredient being served, based on the limit (47) of its calculated weight; the weight of the food served (73) based on the weight of the ordered food; the price of the food served (49) on the basis of the total price of the ordered food; and the total amounts of calories and nutrients of the foods already served, based on the consumption limits, reported in the customer's register.

After reaching the weight of the current ingredient, the employee manually triggers the button (45) to select the next item, thus scrolling through the list of ingredients. Can also press the button (44) to return to the previous ingredient in the list and thus make corrections by adding or removing the ingredient from the dish (41) in order to obey the customer's OP.

As can be seen, the colored graphics (67) present progressive color graduation, for example: green, yellow, orange, and red, according to the increase in the amount of its corresponding item, where the orange color indicates that the quantity is at the limit and red indicates that the said quantity exceeded this limit. Those color indications facilitate the orientation of the kitchen employee and its immediate action, facilitating the assembly of the customer's plate (41).

In this example, shown in FIG. 06, the microcontroller (31) of the DMP (30) is connected in online mode to RTDB, and thus retrieves an OP sent and registered by the device (1) in the RTDB, in list or in the order collection (LOP). In the example, the food “Fish Moqueca” with 200g of weight was ordered.

As can be seen through the display (33) of the DMP the food “Fish Moqueca”, ordered by the customer, is described in the field (33a) along with its composition (46) of ingredients. In this field (33a), the current ingredient selected is the “pepper”, which is marked with the color red, indicating that it is the ingredient to be served.

In the field (33b) are shown the following information:
the “pepper”' weight (64) measured by the scale (“1.9 g”), in red, and its limit de “2 g” (47), next to its colored bar chart (67);
the total weight (73) of the ingredients served of the “Fish Moqueca” (“200 g”), next to its color bar chart (67);
the total price (49) of the food served (“R$ 31.80”);
the total amount (65) of calories and nutrients of food (sugars, sodium, carbohydrates, proteins, fats, fibers, cholesterol, etc.) already served, and the limits (43) of consumption, reported in the customer's register (registration shown in FIGS. 04 and 08) and finally, it is indicated (48) that the food does not have the allergens “Gluten” and “Lactose”.

The microcontroller (31) calculates the price of the food served by the total weight of the ingredients scrolled, according to the sum of their weights measured by the scale (38, 39, 37), discounting the Tare of the plate (41).

The value of each ingredient is calculated by its measured weight, multiplied by the base price of said food (100 grams) recorded in the restaurant's food collection (10b), divided by 100.

Next to each of the results of calculations of the amounts of calories and nutrients (65), color bar graphs (67) are shown, referring to monitoring in relation to their respective limits (43).

As seen in FIG. 06, the colored bar chart (67) is indicating that the cholesterol (“3761.10 mg”) of the food is well above its limit (“63 mg”), established by the customer in its record (FIG. 08, 8a). This can be easily visualized by the red color (63) bar graphs.

Based on the information presented on the DMP display (30) the kitchen employee is allowed to follow the step by step in the service of the OP order.

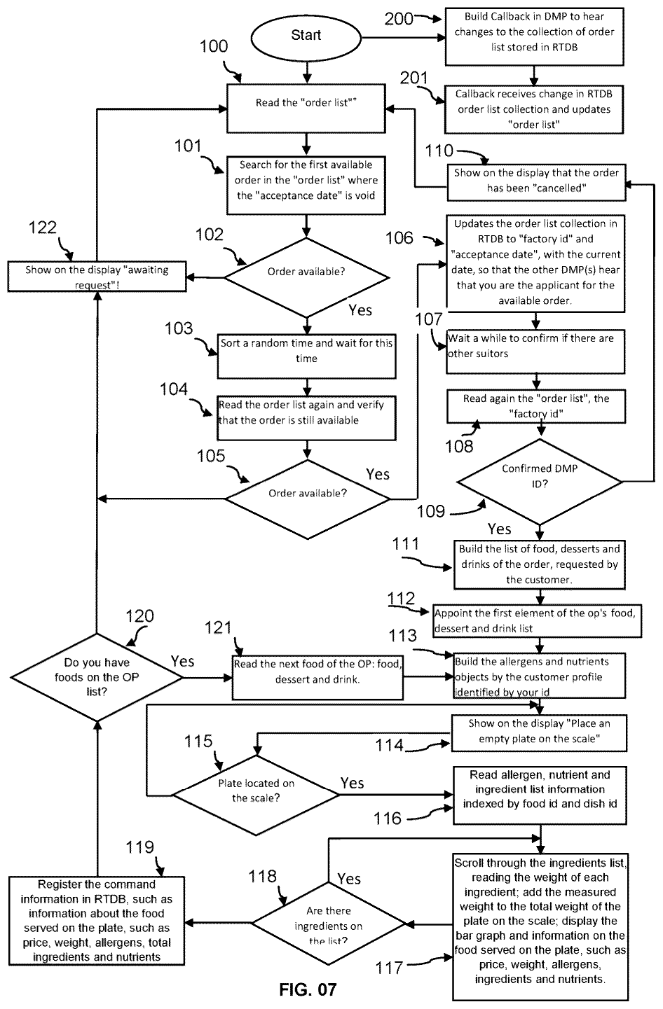

FIG. 07 shows the flowchart of the functioning of the DMP (30), monitoring and weighing device, according to the present invention.

As can be seen, in this flowchart, in the process of initializing the microcontroller (31) is created a main “callback” function of the system [step 200], to maintain an image of the restaurant order list (LOP) in the main RAM memory of the microcontroller (31). This image or collection “ORDER” (FIG. 09) is received by the device “callback” in JSON format every time there is a change in this collection, in RTDB [step 201].

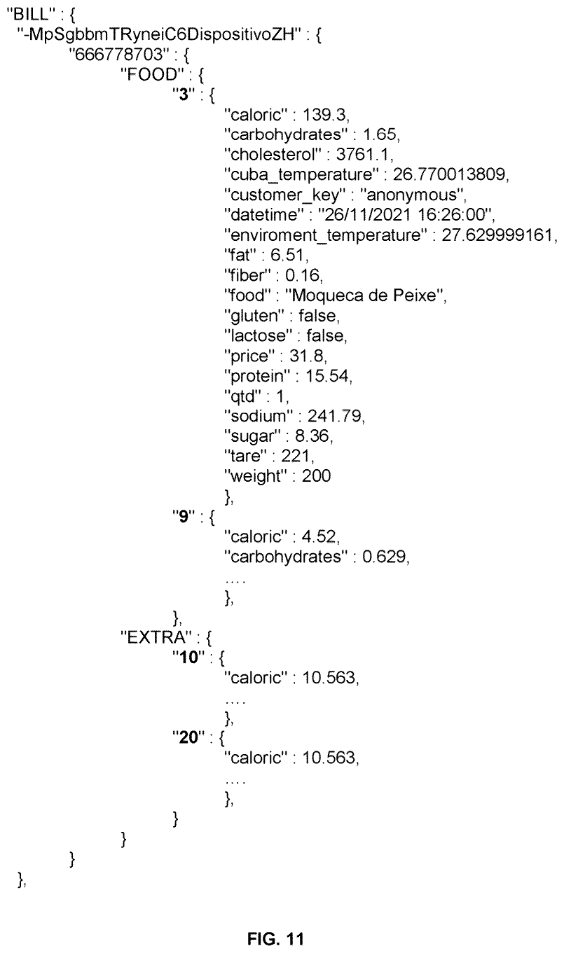

The microcontroller (31) of the DMP device (30), in the “idle” status condition, performs the following operations:
reads the list LOP [step 100] in the main RAM memory of the microcontroller (31) updated by the “callback” function of the device;
searches for the first order available in the list LOP, on condition of “acceptance date” null [step 101];
checks whether the order is available [step 102], where:
if there is no order available in the list, informs on the display (33) of the DMP (30) that it is “waiting for order” [step 122] and reads again the list LOP [step 100], maintaining its status “idle”; or
if an order is available in the list, the device sorts a random time, and waits for this time [step 103];
reads the list LOP again [step 104];
checks whether the order is still available [step 105]:
if the order is not available, informs on the DMP's display (33) that it is “waiting for order” [step 122] and reads the list LOP again [step 100]; or
if the order is available:
updates the OP of the list LOP in RTDB with its “factory id” and “acceptance date” (current date), so that other DMP(s) update themselves by their respective callbacks functions, which is “suitor” to the available order [step 106];
waits a predetermined time to confirm that there are other “suitors” [step 107];
reads again the list LOP and the “factory id” [step 108], to confirm that there was no other “suitor” DMP, whose random time of this DMP was not shorter (faster);
checks whether the DMP ID is confirmed [step 109]:
if the identification has not been confirmed, informs on the display (33) that the order has been “cancelled” [step 110] and reads again the list LOP [step 101]; or
if the identification has been confirmed:
builds the list of food, desserts and beverages of the order (OP), requested by the customer, in the main RAM memory of the microcontroller (31) [step 111];
reads the first item/element of the costumer OP list [step 112];
builds in the main RAM memory of the microcontroller (31) [step 113] the ingredient objects (10b), allergens (10a), nutrients (10c) of the food and also the limits (8a) from profile of the customer identified by their id;
sends a message to the display (33) stating to “put an empty plate on the scale” [step 114];
check whether the plate (41) has been placed on the scale [step 115];
if the plate (41) has not been placed on the scale, keep the message to “put the plate on the scale” [step 114] until the plate (41) is placed on the scale;
if the plate (41) has been placed on the scale:
reads the information in the RDTB of the related food in the OP [step 116], such as: ingredients, allergens, nutrients, Tare, indexed by food id and plate's identification (41), in the main RAM memory of the microcontroller (31);
scrolls through the list of ingredients (meats, vegetables, sauces, cheeses and etc.) of the food established in the OP's food list, where the microcontroller (31): reads the weight of the plate (41), discounting its Tare on the scale; calculates the weight of each ingredient scrolled and adds the weight of each ingredient to the total weight of the food served on the plate (41); and dynamically shows, on the display (33), in real time, the result of the calculation: the weight of the ingredient of the food served; the total weight of the food served; the total price of the food served; the results of calculations of the total amounts of calories and other nutritional information of the food; generates and shows on the display (33b) the colored bar charts referring to the monitoring of each item calculated in relation to its limit, such as: calculated weight of the current ingredient; weight of food; and limits of calories and nutrients established in the client's register or, in the absence of limits in the register, the limits established in the nutritional table of the restaurant registered in the RTDB; and informs whether the food served has allergens [step 117];
checks whether the list of ingredients indexed by food id has ended [step 118];
if the list of ingredients indexed by the id has not finished: continue to scroll through the list as in step 117 until there are no more ingredients;
if there are no more ingredients in the list of ingredients indexed by the DMP id:
records in RTDB the information related to the food served, forming an Electronic Command [step 119];
Check for more food in the OP [step 120]:
if there is no more food in the OP, send message to the display (33) “waiting for order” [step 122] and back to read the list LOP in the main RAM memory of the microcontroller (31) [step 100];
if there are more foods on the OP's food list:
reads the next food of the OP [step 121], constructing the objects, such as allergens, nutrients and food ingredients, in the main RAM memory of the microcontroller (31), as established in the list of food and ingredients of the restaurant, repeating steps 113, 114, 115, 116, 117, 118 119, 120 and 121, and systematically updating the “Electronic Command” (FIG. 11) with the measured values, until there is no more food in the OP.

As seen, by the operational steps of the DMP, shown in the flowchart of FIG. 07, the DMP guides and assists the employee, through its touchscreen display, in the step by step of assembling the costumer's food, to fulfill the customer's personalized order.

In those examples, the plate (41) can be understood by: crockery if the customer has requested service in the restaurant itself, or, packaging/travel containers, if the order has been requested to deliver.

Thus, when starting the orientations, the microcontroller (31) of the DMP presents the food items of the OP instructing the employee to place each food in the dish (41), in the quantity established by the client in the OP.

FIG. 08 exemplifies a JSON structure, named “CUSTOMER”, containing the record of the customer's registration information and its limits (8a) in the RTDB, as in the present invention.

FIG. 09 exemplifies a JSON structure, named “ORDER”, representing the list LOP that has one or more OP, registered in the RTDB by the device (1). Each OP in that list LOP contains the order number, customer ID, food identification, etc. This list of items ordered by the customer is accessed by all DMP(s) in the kitchen. One of the DMP(s) will be the “executor” of the fulfillment of the request, guiding the kitchen employee in the assembly of this order.

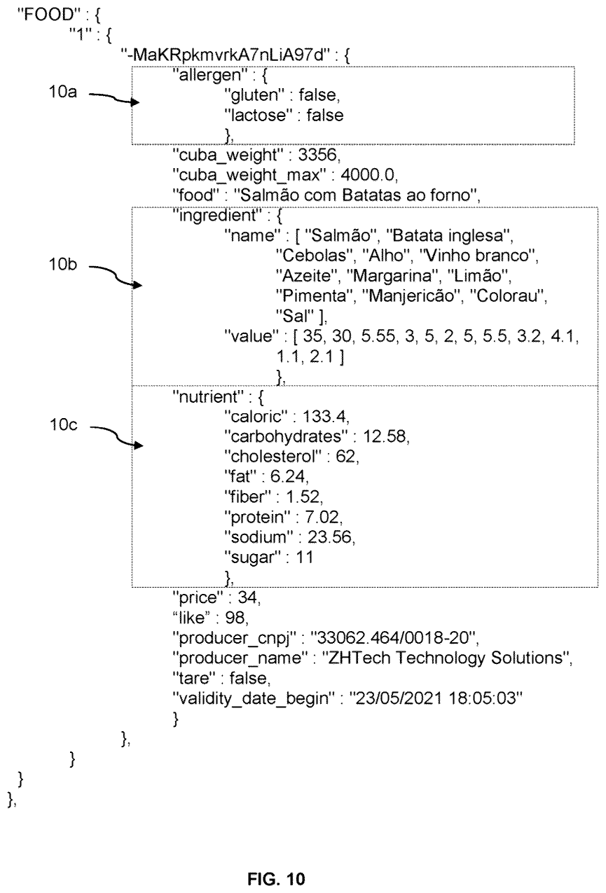

FIG. 10 shows an example of the record with a JSON structure, named “FOOD”, containing an example of information from one of the food from the restaurant's menu, registered in the RTDB, preferably registered by the chef of the restaurant, assisted by a nutritionist. In this example, the food information records of the dish “roasted Salmon with potatoes” are presented, such as: their ID, their ingredients (10b) and allergens (10a), price, nutritional content (10c), producer data and their expiration date.

FIG. 11 shows a list of items from the Electronic Command registered in the RTDB, in the JSON format named “BILL”, as in the present invention. In this list, foods are identified, with their nutritional contents, weights and measured values, date and time of purchase, identification, etc.

Although examples of achievements of the System and Automation Method for restaurants, Monitoring and Weighing IoT Device for restaurants, Method and Device to orders for restaurant, built according to the teachings of the invention have been described here, the scope of coverage of this patent is not limited to this.

On the contrary, this patent covers all personifications of the teachings of invention falling fairly within the scope of the attached claims, literally or under the doctrine of the equivalents.

1. An automation system for restaurants, characterized by comprising:
server (20) to provide restaurant services and control payments for the sale of food;
low latency RTDB database, containing information about: restaurant plates (41); menus and food information; registration with nutritional information of the client; the list of orders (LOP) to be fulfilled; wherein the database is synchronized with devices (1) and DMP(s) (30), where devices (1) and DMP(s) (30) share instances of the data bank in order to receive updates to the latest data;
at least one device (1), to create Orders (OP) discriminating the weight of food, quantity of beverages or desserts and their prices, and send them for registration in the list of Orders (LOP) of the restaurant's RTDB database, where the device (1) has instructions stored in your memory, which when executed make your processor operate, as follows:
a) upon receiving manual input regarding restaurant selection, the device processor (1) retrieves information from the RTDB database, and stores in its memory an inventory of menus, calories, nutrients and ingredients, their compositions and properties, and customer profile data;
b) upon receiving manual input related to a selected menu it creates and shows in the GUI display to select food;
c) upon receiving manual input on the GUI to select food, creates and displays on the display, a GUI to order the food with a numerical text box (55) which, according to the selected menu, receives the amount of food by weight (g) or by number of units;
d) upon receiving manual input, establishing the quantity of the selected food, the device (1) retrieves the information stored in it's memory and shows it on the display, through the GUI to order: the results of calculations of the amounts of calories and nutrients; the bar charts with gradual colors resulting from the monitoring of the results of calculations in relation to the limits per meal registered in the RTDB; the information for the food selected by the customer; allergens; and the information of limits registered in the RTDB, allowing the customer to verify that the chosen foods are within the predetermined diet restrictions established by their food schedule, with options to confirm or modify their order before closing the order;
e) If the client modifies the ordering of the food, repeats steps “b” to “d” for the modified selection and confirmation or modification of the weight or quantity of food; and
f) when the customer confirms the weight of the food or quantity, the device (1) configures in the OP the information of the food selected for shipment to the DMP unit;
at least one Monitoring and Weighing Device (DMP) (30) to retrieve and guide the fulfillment of an Order (OP) not met, generated and registered in the list (LOP) of the RTDB by the device (1), wherein its microcontroller (31) keeps an image of the list LOP in its memory RAM, and informs on its touchscreen display (33): the presence of the plate (41) with RFID, on the scale; and it guides in the sequence of the collect of each ingredient that composes the food ordered in the OP, calculating the weight of each ingredient of the food to be served, measuring the weight of the ingredient served through load cells (38, 39), calculating the total amount nutritional/caloric values of the food served, monitoring the weight of the ingredient served and the total amount nutritional/caloric values of the total foods served; and dynamically showing its results, informing the limits of these values by the customer profile, where the monitoring of the calculated and measured values are shown through colored graphs, in order to guide the OP service through the weight of the ingredient, monitoring, identification and sequence of ingredients to be served.

2. The automation system for restaurants, according to claim 1, characterized by the device (1) having open operating system comprising: at least one core processor (CPU) and a main memory, touch screen, a sound input and output unit, a camera unit, a wireless network communication module, a battery to power, where the CPU is connected to each function component through an internal bus of the device.

3. The automation system for restaurants, according to claim 2, characterized by the operations of the device (1) comprise:
access/retrieve information recorded in the RTDB database;
create a first graphical interface of the user GUI (la), which is sent for screen display of the device (1), where the GUI (1a) comprises: elements for access to the account/customer registration (70); elements (69) for restaurant selection; elements (62) for the selection of restaurant food menus; element (50) for the opening of the Order (OP); and indicator of the number of items (59) of the OP;
receive a manual entry relating to an element (70) of the GUI (1a), and create a GUI (1e), for registration/access of the customer's account, where the GUI (1e) comprises: forms to register, in the RTDB, the information about the customer and his food profile;
receive a manual entry relating to an element (69) for restaurant selection, of the GUI (1a), and release the access to the selection of menus (62) of the chosen restaurant;
receive a manual entry relating to an element (62) of menu selection of the GUI (1a), and create a second GUI (1b) for dish/food selection, comprising: element (50) to access the OP; indicator element of the number “N” (59) of OP items; and the list of dishes/foods of the menu selected in the GUI (1a) containing element (25) for selection of dish/food, corresponding to the name of the dish/food, composition of ingredients, price by base weight, and icon “like” (53);
receive a manual entry relating to an element (25) of the GUI's list of dishes/foods (1b), and create a third GUI (1c) to order portions of the dish/food through its weight (55), where the GUI (1c) comprises: icon “like” (53); element (50) to access the OP; element (68) to add food to the OP;
indicator element of the number “N” (59) of OP items; information about the food chosen with food identification (25) and its ingredients (51); numerical text box (55) to receive a manual input of the weight of the food; the price (56) calculated for the weight of the ordered food; and information field (52) that dynamically presents the results of calculations: of the weight and total price of the selected foods; of the total amounts of calories and nutrients for each item of food content of the selected foods; the limits (43) of consumption per meal for each of these items; the colored bar charts (67), resulting from monitoring the price, weight and total amounts of calories and nutrients, based on the limits (43); and indicates the existence of allergens (60) in food;
receive a manual entry relating to an element (62) to selection of menus of beverages/desserts of the GUI (1a), and create a second GUI (1b) for selection of beverages/desserts, comprising: element (50) to access the OP; indicator element of the number “N” (59) of OP items; and the list of beverages/desserts of the menu selected in the GUI (1a) containing element (25) for selection of the beverage, corresponding to the name of the beverages, and icon “like” (53);
receive a manual entry by an element (25) of the GUI beverage list (1b), and create a third GUI (1c) to order the number of units of the selected beverage/dessert, where the GUI (1c) comprises: icon “like” (53); element (50) to access the OP; element (68) to add food to the OP; indicator element of the number “N” (59) of OP items; information about the selected beverage/dessert, with its identification (25); numerical text box (55) to receive a manual entry of the number of units of the selected beverage/dessert; the price (56) calculated for the amount of beverage/dessert ordered; and information field (52) that dynamically presents the results of calculations: of the weight and total price of selected foods for the OP; the total amounts of calories and nutrients for each item of food content of the selected foods; the limits (43) of consumption per meal for each of these items; the colored bar charts (67), resulting from the monitoring of price, weight and total amounts of calories and nutrients, based on limits (43); and indicates the existence of allergens (60) in food;
receive manual input relating to the element (68) of the third GUI (1c), and create a data structure for the selected food, in a fourth GUI (1d) to ordering, being that in the GUI (1d) is configured: the code of the ordering (OP); the code of the food and its name; the weight/amount of the food and its price (56); the result of calculating the “total price” of the ordering (61); elements “exclude” (66), to exclude the selected foods; the “Continue shopping” element (58), to back to select new items; and the “Buy” element (57), to complete the purchase of the order; upon completion of the purchase of the food (57), to send and register the OP in a list of orders (LOP) in the RTDB database.

4. The automation system for restaurants, according to claim 3, characterized by the elements for access (50), exclusion (66), “Continue buying” (58), “buy” (57) and selection (62; 69; 50; 70) of GUI(s) (1a; 1b; 1c; 1d; 1e) are buttons triggered by touch.

5. The automation system for restaurants, according to claim 1, characterized by the fact that DMP (30) comprises:
a main memory (RAM) containing stored instructions;
a microcontroller (31), with Wi-Fi connectivity (14), which has an internal factory identifier;
a scale (38; 39; 37) connected to the microcontroller (31), to provide information on the weight of the plate (41);
an RFID reader (32) connected to the microcontroller (31), arranged on the scale (38; 39; 37), to identify the plate (41) by the ID of its RFID device (42), fixed at the bottom of the plate;
a graphic display (33) connected to the microcontroller (31), to present images with orientations and, show in real time, the information data related to the food served on the plate (41);
a temperature sensor (36), connected to the microcontroller (31), to measure the temperature of ambient and of the food to be served on the plate (41);
a buzzer signaling device (35) connected to the microcontroller (31) to beep alertly;
an antenna (13) for Wi-Fi network, connected to the microcontroller (31), to transmit and receive information from the RTDB database, through a local router device (14) of the restaurant; an electric power source (34), which includes a renewable battery, allowing the mobility of the DMP (30), which is monitored by one of the GPIO ports (17) of the microcontroller (31), to perform the measurement and monitoring of the voltage level of that battery.

6. The automation system for restaurants, according to claim 5, characterized by having instructions stored in the memory RAM of the DMP (30), which when executed by the microcontroller (31), cause the microcontroller (31) to perform operations that are comprising:
when initializing the microcontroller (31), create the “callback” function on the system, to create an image of the restaurant order list (LOP), in the main “RAM” memory of the microcontroller (31), keeping this list up to date;
staying connected to the RTDB database by reading the order list (LOP) by the “callback” asynchronous function of the device, in order to check whether or not there is a new OP available or open;
read the list LOP in the main “RAM” memory of the microcontroller (31) updated by the “callback” function of the device;
search for an OP available in the list LOP, with the condition of “acceptance date” null;
inform on the display (33) of the DMP (30) that it is “waiting for order” maintaining its status “idle”, until it finds an OP available in the list LOP;
when finding an OP available in the list LOP, sort a random time and wait for this time;
check that the OP is still available, keeping message, “waiting for order”;
if the OP is available, update the OP in the RTDB with its “factory id” and “acceptance date”, with the current date, so that other DMP(s) are updated by their respective “callback” functions, so that they know there is the applicant for the available order;
wait a predetermined time to confirm that there is another DMP applicant;
read again the “factory id” of the OP, to confirm that there was no other DMP applicant, with shorter random time;
if the identification has not been confirmed, inform in the display (33) that the request has been “cancelled” and go back read the list LOP in the main RAM memory of the microcontroller (31);
if identification has been confirmed, build the list of food, desserts and beverages of the order (OP), requested by the customer, in the main RAM memory of the microcontroller (31);
read the first item on the client's OP list;
build the allergens and nutrients objects by the customer profile identified by their id, in the main RAM memory of the microcontroller (31);
send message to the display (33) stating to “put an empty plate on the scale”;
check if the plate (41) has been placed on the scale, through the RFID reader (32) of the scale;
if the plate (41) has not been placed on the scale, keep the message to “put the plate on the scale” until the mentioned plate (41) is placed on the scale;
if the plate (41) was placed on the scale, read the information in the RDTB of the food listed in the OP, being that the ingredients, allergens, nutrients and Tare of the plate are indexed by the food id and plate id, in the main RAM memory of the microcontroller (31);
scroll through the list of food ingredients, and:
read the weight of the food(s) of the plate (41), discounting the Tare of the plate;
calculate the weight of each ingredient scrolled and add each weight to the total weight of the food served on the plate (41); and
show dynamically, on the display (33), in real time: the result of calculating the weight of the food ingredient; the total weight of the food; the price of food; the results of calculations of the total amounts of calories and nutrients of the food served; the colored bar charts generated to show the monitoring of each item calculated in relation to its maximum limit; the maximum limits of calories, nutrients and price; and food allergens;
checks whether the list of ingredients indexed by the food id has ended;
if the list of ingredients indexed by the food id has not finished, continue to scroll through the list until there are no more ingredients; or
if there are no more ingredients in the list of ingredients indexed by the DMP's id, register in the database (RTDB) the information related to the food served, forming an “Electronic Command”;
check for more food item on the OP's food list;
if there is no more food item in the OP list, send message to the display (33) “waiting for order”, and go back read the list LOP in the main RAM memory of the microcontroller (31);
if there are more foods in the OP food list, read the next food (9d; 9c) from the OP list (9b), and consecutively build objects such as allergens, nutrients, and food ingredients, in the main RAM memory of the microcontroller (31), repeating the steps described earlier and systematically updating the “Electronic Command”, with the measured values.

7. The automation system for restaurants, according to claim 6, characterized in that the display (33) of the DMP device (30) is a TFT LCD touch-sensitive display.

8. The automation system for restaurants, according to claim 7, characterized by the fact that the scale (38; 39; 37) of the DMP device (30) is comprised by two load cells (38; 39) connected by two channels (16) to an amplifier and digital analog converter (CAD) (37), which is connected to the microcontroller (31) by I2C communication.

9. The automation system for restaurants, according to claim 8, characterized by the fact that the RFID reader (32) of the DMP device (30) is arranged on the scale (38; 39; 37), in an integrated way, between the load cells (38; 39), and under a demarcation (40) in the form of a plate, to indicate the positioning of the plate (41), on the scale (38; 39; 37).

10. The automation system for restaurants, according to claim 9, characterized by the fact that the DMP device (30) comprises a control to select/indicate the order of selection of the ingredient to be served.

11. The automation system for restaurants, according to claim 10, characterized by the control to select/indicate the order of selection of the ingredient to be served, be carried out by the microcontroller (31) by receiving manual input referring to the elements (45; 44) of the display (33), where element (45) advances in the list of ingredients, for the next ingredient to be served and the element (44) goes back in the list to the ingredient previously served.

12. The automation system for restaurants, according to claim 10, characterized by the fact that the control to select/indicate the order of selection of the ingredient to be served, is carried out automatically by the microcontroller (31), by controlling the weight of the ingredient served, having as reference its maximum limit, and when reaching the weight limit the microcontroller emits a signal indicating that it will give sequence in the order of selection of the ingredient to be Served, indicating when the weight of the ingredient reaches its limit.

13. The automation system for restaurants, according to claim 6, characterized by the plates (41) of the restaurant have RFID identification device (42) arranged in its bottom (41a), to identify the plates and the fulfillment of the order.

14. The automation system for restaurants, according to claim 13, characterized by the fact that the RFID device (42) fixed on the bottom (41a) of the plate (41) is in the form of self-adhesive label, allowing it to be replaced when damaged.

15. The automation system for restaurants, according to claim 14, characterized by the fact that the RFID device (42) fixed at the bottom (41a) of the plate (41) is coated with waterproof coating.

16. The automation system for restaurants, according to claim 13, characterized by the fact that the RFID device (42) fixed at the bottom (41a) of the plate (41) is embedded inside the bottom of the dish (41a).

17. The automation system for restaurants, claim 5, characterized by the fact that the temperature sensor (36) of the DMP device (30) be an infrared sensor.

18. A Monitoring and Weighing Device for Restaurants characterized by having instructions stored in its main memory (RAM), which when executed by the microcontroller (31), cause the microcontroller (31) to perform operations that comprise:
when initializing the microcontroller (31), create the “callback” function on the system, to create an image of the restaurant order list (LOP) in the main RAM memory of the microcontroller (31), keeping the list up to date;
staying connected to the RTDB database by reading the order list (LOP) by the “callback” asynchronous function of the device, in order to check whether or not there is a new order (OP) available or open;
read the list LOP in the main RAM memory of the microcontroller (31) updated by the callback function of the device;
search for an OP available in the list LOP, with the condition of “acceptance date” null;
inform, on the display (33) of the DMP (30), that it is “waiting for order” maintaining its status “idle”, until it finds an OP available in the list LOP;
when finding an OP available in the list LOP, sorts a random time and wait for this time;
check that the OP is still available, keeping message, “waiting for order”;
if the OP is available, update the OP in the RTDB with its “factory id” and “acceptance date”, with the current date, so that other DMP(s) are updated by their respective “callback” functions, so that they know there is the applicant for the available order;
wait a predetermined time to confirm that there is another DMP applicant;
read again the “factory id” of the OP, to confirm that there was no other DMP applicant, with shorter random time;
if the identification has not been confirmed, inform on the display (33) that the request has been “cancelled” and back to read the list LOP in the main RAM memory of the microcontroller (31);
if identification has been confirmed, build the list of food, desserts and drinks beverages of the order (OP), requested by the customer, in the main RAM memory of the microcontroller (31);
read the first item on the client's OP list;
build the allergens and nutrients objects by the customer profile identified by their id, in the main RAM memory of the microcontroller (31);
send message to the display (33) stating to “put an empty plate (41) on the scale”;
check that the plate (41) has been placed on the scale, through the RFID reader (32) of the scale;
if the plate (41) has not been placed on the scale, keep the message to “put the plate on the scale” until the mentioned plate (41) is placed on the scale;
if the plate (41) was placed on the scale, read the information in the RDTB of the food listed in the OP, being that the ingredients, allergens, nutrients and Tare of the plate are indexed by the food id and plate id, in the main RAM memory of the microcontroller (31);
scroll through the list of food ingredients, and:
read the weight of the food(s) of the plate (41), discounting the Tare of the plate;
calculate the weight of each ingredient scrolled and add each weight to the total weight of the food served on the plate (41); and
show dynamically, on display (33), in real time: the result of calculating the weight of the food ingredient; the total weight of the food; the price of food; the results of calculations of the total amounts of calories and nutrients; the colored bar charts generated to show the monitoring of each item calculated in relation to its maximum limit; the maximum limits of calories, nutrients and price; and food allergens;
checks whether the list of ingredients indexed by the food id has ended;
if the list of ingredients indexed by the id has not finished, continue to scroll through the list until there are no more ingredients; or
if there are no more ingredients in the list of ingredients indexed by the DMP's id, register in the database (RTDB) the information related to the food served, forming an “Electronic Command”;
check for more food on the OP's food list;
if there is no more food item in the OP list, send messages to the display (33) “waiting for order”, and back to read the list LOP in the main RAM memory of the microcontroller (31);
if there are more foods in the OP food list, read the next food (9d and 9c) of the OP (9b), and continue to scroll through the OP food list (9b) to the last food, systematically building the allergenic objects (10a), nutrients (10c) and ingredients (10b) of the food, in the main RAM of the microcontroller (31), as set out in the restaurant's food and ingredients list, returning to repeat the steps described earlier from the step to “build the allergen and nutrient objects by the customer profile identified by their id, in the main RAM memory of the microcontroller” and systematically updating the Electronic Command, with the measured values.

19. The Monitoring and Weighing Device for restaurant, according to claim 18, characterized by the fact that it comprises:
a microcontroller (31), with Wi-Fi connectivity (14), which has an internal identifier;
a scale (38; 39; 37) connected to the microcontroller (31), to provide information on the weight of the plate (41);
an RFID reader (32) connected to the microcontroller (31), arranged on the scale (38; 39; 37), to identify the plate (41) by ID (42) of its RFID device, fixed at the bottom of the plate;
a graphic display (33) connected to the microcontroller (31), to present images with orientations and, show in real time, the information data related to the food served on the plate (41);
a temperature sensor (36), connected to the microcontroller (31), to measure the temperature of the ambient and of the food to be served on the plate (41);
a buzzer signaling device (35) connected to the microcontroller (31) to beep alertly;
an antenna (13) for Wi-Fi network, connected to the microcontroller (31), to transmit and receive information from the RTDB database, through a local router device (14) of the restaurant;
an electric power source (34), which includes a renewable battery, allowing the mobility of the DMP (30), which is monitored by one of the GPIO ports (17) of the microcontroller (31), to perform the measurement and monitoring of the voltage level of that battery.

20. The Monitoring and Weighing Device for Restaurant, according to claim 19, characterized by the fact that the microcontroller (31) is a “ESP32” type microcontroller.

21. The Monitoring and Weighing Device for Restaurant, according to claim 19, characterized by the fact that the microcontroller (31) is a “Raspberry Pi” type microcontroller.

22. The Monitoring and Weighing Device for Restaurant, according to claim 20, characterized by the fact that the display (33) is a touch sensitive TFT LCD graphic display.

23. The Monitoring and Weighing Device for Restaurant, according to claim 22, characterized by the fact that the scale (38; 39; 37) is comprised by two load cells (38;

39. connected by two channels (16) to an amplifier and digital analog converter (CAD) (37) which is connected to the microcontroller (31) by I2C communication.

24. The Monitoring and Weighing Device for Restaurant, according to claim 23, characterized by the fact that the RFID reader (32) is arranged on the scale (38; 39; 37), in an integrated way, between the load cells (38; 39), and under a demarcation (40) in dish form, to indicate the positioning of the dish (41), on the scale (38; 39; 37).

25. The Monitoring and Weighing Device for Restaurant, according to claim 19, characterized by the fact that the temperature sensor (36) being an infrared sensor.

26. The Monitoring and Weighing Device for restaurant, according to claim 25, characterized by the fact that it comprises a control to select/indicate the order of selection of the ingredient traveled to be served.

27. The Monitoring and Weighing Device for restaurant, according to claim 26, characterized by the fact that the control to select/indicate the order of selection of the ingredient to be served is performed by the microcontroller (31) when it receives a manual input referring to the elements (45; 44) of the display (33), where the element (45) advances to the next ingredient to be served and the element (44) goes back in the list to the ingredient served previously served.

28. The Monitoring and Weighing Device for restaurant, according to claim 26, characterized by the fact that the control to select/indicate the order of selection of the ingredient to be served, be performed automatically by the microcontroller (31), by controlling the weight of the ingredient served, having as reference its maximum limit, and when reaching the limit weight the microcontroller emits signal indicating that it will give sequence in the order of selection ingredient to be served, indicating when the weight of the ingredient reaches its limit.

29. An automation method for restaurants, characterized by:
place food orders, by executing instructions stored in a device (1) memory, which when executed, cause the device (1) processor to perform operations that comprise:
access/retrieve information recorded in the RTDB database;
create a first graphical interface of the user GUI (1a), which is sent for screen display of the device (1), where the GUI (1a) comprises: elements for access to the account/customer registration (70); elements (69) for restaurant selection; elements (62) for the selection of restaurant food menus; element (50) for the opening of the Order (OP); and indicator of the number of items (59) of the OP;
receive a manual entry relating to an element (70) of the GUI (1a), and create a GUI (1e), which is sent for display on screen of the device (1), for registration/access of the customer's account, where the GUI (1e) comprises: forms to register, in RTDB, the information about the customer and his food profile;
receive a manual entry relating to an element (69) for restaurant selection, of the GUI (1a), and release the access to the selection of menus (62) of the chosen restaurant;
receive a manual entry relating to an element (62) of menu selection of GUI (1a), and create a second GUI (1b) for dish/food selection, which is sent for screen display of the device (1), comprising: element (50) to access the OP; indicator element of the number “N” (59) of OP items; and the list of dishes/foods of the menu selected in the GUI (1a) containing element (25) for selection of dish/food, corresponding to the name of the dish/food, composition of ingredients, price by base weight, and icon “like” (53);
receive a manual entry relating to an element (25) of the GUI's list of dishes/foods (1b), and create a third GUI (1c) to order portions of the dish/food through its weight (55), which is sent for display on the device screen (1), where the GUI (1c) comprises: icon “like” (53); element (50) to access the OP; element (68) to add food to the OP; indicator element of the number “N” (59) of items of the OP; information about the food chosen with identification of the food (25) and its ingredients (51); numerical text box (55) to receive a manual input of the weight of the food; the price (56) calculated for the weight of the ordered food; and information field (52) that dynamically presents the results of calculations: of the weight and total price of the selected foods; of the total amounts of calories and nutrients for each item of food content of the selected foods; the limits (43) of consumption per meal for each of these items; the colored bar charts (67), resulting from the monitoring of price, weight and total amounts of calories and nutrients, based on limits (43); and indicates the existence of allergens (60) in food;
receive a manual entry relating to an element (62) selection of menus of beverages/desserts of the GUI (1a), and create a second GUI (1b) for selection of beverages/desserts, which is sent for display on screen of the device (1), comprising: element (50) to access the OP; indicator element of the number “N” (59) of OP items; and the list of drinks/desserts of the menu selected in the GUI (1a) containing element (25) for selection of the beverage/dessert, corresponding to the name of the beverage/dessert, and icon “like” (53);
receive a manual entry by an element (25) of the GUI beverage/dessert list (1b), and create a third GUI (1c) to order the number of units of the selected beverage/dessert, which is sent for screen display of the device (1), where the GUI (1c) comprises: icon “like” (53); element (50) to access the OP; element (68) to add food to the OP; indicator element of the number “N” (59) of items of the OP; information about the selected beverage/dessert, with its identification (25); numerical text box (55) to receive a manual entry of the number of units of the selected beverage/dessert; the price (56) calculated for the amount of beverages/desserts ordered; and information field (52) that dynamically presents the results of calculations: weight and total price of selected foods; the total amounts of calories and nutrients for each item of food content of the selected foods; the limits (43) of consumption per meal for each of these items; the colored bar charts (67), resulting from the monitoring of price, weight and total amounts of calories and nutrients, based on limits (43); and indicates the existence of allergens (60) in food;
receive manual input relating to the element (68) of the third GUI (1c), and create a data structure of the selected food, in a fourth GUI (1d) to ordering, being that in the GUI (1d) is configured: the code of the ordering (OP); the code of the food and its name; the weight/amount of the food and its price (56); calculation result of the “total price” of the ordering (61); elements “exclude” (66) to exclude selected foods; “Continue shopping” element (58) to back to select new items; and “Buy” element (57) to complete the purchase of the order;
after the order purchase is completed (57), send and register the OP in an order list (LOP) in the RTDB database;
retrieve the OP registered in the LOP of the RTDB database, through a Monitoring and Weighing Device (30) (DMP) comprising a display, a scale, a microcontroller (31) and instructions stored in a main RAM memory that, when executed, cause the microcontroller to perform operations that comprise:
when initializing the microcontroller (31), create “callback” function on the system, to create an image of the restaurant order list (LOP) in the main RAM memory of the microcontroller (31), keeping the list up to date;
staying connected to the RTDB database by reading the order list (LOP) by the “callback” asynchronous function of the device, in order to check whether or not there is a new OP available or open;
read the list LOP in the main RAM memory of the microcontroller (31) updated by the “callback” function of the device;
search for an OP available in the list LOP, with the condition of “acceptance date” null;
inform on the display (33) of the DMP (30) that it is “waiting for order” maintaining its status “idle”, until it finds an OP available in the list LOP;
when finding an OP available in the list LOP, sort a random time and wait for this time;
check that the OP is still available, keeping the message, “waiting for order”;
if the OP is available, update the OP in the RTDB with its “factory id” and “acceptance date”, with the current date, so that other DMP(s) are updated by their respective “callbacks” functions, so that they know there is the applicant for the available order;
wait a predetermined time to confirm that there is another DMP applicant;
read again the “factory id” of the OP, to confirm that there was no other DMP applicant, with shorter random time;
if the identification has not been confirmed, inform in the display (33) that the request has been “cancelled” and go back read the list LOP in the main RAM memory of the microcontroller (31);
if identification has been confirmed, build the list of food, desserts and beverages of the order (OP), requested by the customer, in the main RAM memory of the microcontroller (31);
read the first item on the client's OP list;
build the allergens and nutrients objects by the customer profile identified by their id, in the main RAM memory of the microcontroller (31);
send message to the display (33) stating to “put an empty plate on the scale”;
check if the plate (41) has been placed on the scale, through the RFID reader (32) of the scale and RFID of the bottom of the plate (41);
if the plate has not been placed on the scale, keep the message to “put the plate on the scale” until the mentioned plate (41) is placed on the scale;
if the plate (41) was placed on the scale, read the information in the RDTB of the food listed in the OP, being that the ingredients, allergens, nutrients and Tare of the plate (41) are indexed by the food id and plate id, in the main RAM memory of the microcontroller (31);
scroll through the list of food ingredients, and:
read the weight of the food(s) of the plate (41), discounting the Tare of the plate;
calculate the weight of each ingredient scrolled and add each weight to the total weight of the food served on the plate (41); and
dynamically show, on display (33), in real time: the result of calculating the weight of the food ingredient; the total weight of the food; the price of food; the results of calculations of the total amounts of calories and nutrients of the food served; the colored bar charts generated to show the monitoring of each item calculated in relation to its maximum limit; the maximum limits of calories, nutrients and price; and food allergens;
check whether the list of ingredients indexed by food id has ended;
if the list of ingredients indexed by the id has not finished, continue to scroll through the list until there are no more ingredients; or
if there are no more ingredients in the list of ingredients indexed by the DMP's id, register in the database (RTDB) the information related to the food served, forming an “Electronic Command”;
check for more food item on the OP's food list;
if there is no more food item in the OP list, send message to the display (33) “waiting for order”, and go back read the list LOP in the main RAM memory of the microcontroller (31);
if there is more foods in the OP food list, read the next food (9d; 9c) of the OP list (9b), and continue to scroll through the OP food list (9b) to the last food, systematically building the allergenic objects (10a), nutrients (10c) and ingredients (10b) of the food, in the main RAM of the microcontroller (31), as set out in the restaurant's food and ingredients list, returning to repeat the steps described earlier from the step to “build the allergen and nutrient objects by the customer profile identified by their id, in the main RAM memory of the microcontroller” and systematically updating the Electronic Command, with the measured values.

30. A Method to Order Food for Restaurant, characterized by ordering through devices (1) to order, comprising a touch screen, a processor, and a memory storing instructions that, when executed by the processor, cause the processor to perform operations that comprise:
access/retrieve information recorded in the RTDB database;
create a first graphical interface of the user (GUI (1a)), which is sent to the display of the device (1), where the GUI (1a) comprises: elements for access to the account/customer registration (70); elements (69) for restaurant selection; elements (62) for the selection of restaurant food menus; element (50) for the opening of the Order (OP); and indicator of the number of items (59) of the OP;
receive a manual entry relating to an element (70) of the GUI (1a), and create a GUI (1e), which is sent to the display of the device (1), for registration/access of the customer's account, where the GUI (1e) comprises: forms to register, in the RTDB, the information about the customer and his food profile;
receive a manual entry for one of the elements (69) for restaurant selection, GUI (1a), and free up access to the selection of menus (62) of the chosen restaurant;
receive a manual entry relating to an element (62) of menu selection of the GUI (1a), and create a second GUI (1b) for dish/food selection, which is sent to the display of the device (1), comprising: element (50) to access the OP; indicator element of the number “N” (59) of OP items; and the list of dishes/foods of the menu selected in the GUI (1a) containing element (25) for selection of dish/food, corresponding to the name of the dish/food, composition of ingredients, price by base weight, and icon “like” (53);
receive a manual entry relating to an element (25) of the GUI's list of dishes/foods (1b), and create a third GUI (1c) to order portions of the dish/food through its weight (55), which is sent to the display of the device (1), where the GUI (1c) comprises: icon “like” (53); element (50) to access the OP; element (68) to add food to the OP; indicator element of the number “N” (59) of items of the OP; information about the food chosen with identification of the food (25) and its ingredients (51); numerical text box (55) to receive a manual input of the weight of the food; the price (56) calculated for the weight of the ordered food; and information field (52) that dynamically presents the results of calculations: of the weight and total price of selected foods; of the total amounts of calories and nutrients for each item of food content of the selected foods; the limits (43) of consumption per meal for each of these items; the colored bar charts (67), resulting from the monitoring of price, weight and total amounts of calories and nutrients, based on limits (43); and indicates the existence of allergens (60) in food;
receive a manual entry relating to an element (62) to selection of the GUI beverages/desserts menu (1a), and create a second GUI (1b) for selection of beverages/desserts, which is sent to display on screen of the device (1), comprising: element (50) to access the OP; indicator element of the number “N” (59) of OP items; and the list of beverages/desserts of the menu selected in the GUI (1a) containing element (25) for selection of the beverage/dessert, corresponding to the name of the beverage/dessert, and icon “like” (53);
receive a manual entry relating to an element (25) from the GUI beverages/desserts list (1b), and create a third GUI (1c) to order the number of units of the selected beverage/dessert, which is sent to screen display of the device (1), where the GUI (1c) comprises: icon “like” (53); element (50) to access the OP; element (68) to add food to the OP; indicator element of the number “N” (59) of items of the OP; information about the selected beverage/dessert, with its identification (25); numerical text box (55) to receive a manual entry of the number of units of the selected beverage/dessert; the price (56) calculated for the amount of beverages/desserts ordered; and information field (52) that dynamically presents the results of calculations: of the weight and total price of the foods selected for the OP; the total amounts of calories and nutrients for each item of food content of the selected foods; the limits (43) of consumption per meal for each of these items; the colored bar charts (67), resulting from the monitoring of price, weight and total amounts of calories and nutrients, based on limits (43); and indicates the existence of allergens (60) in food;
receive manual input relating to the element (68) of the third GUI (1c), and create a data structure for the selected food, in a fourth GUI (1d) to ordering the order, being that in GUI (1d) are configured: the code of the OP; the code of food and its name; the weight/amount of the food and its price (56); the result of calculating the “total price” of the ordering (61); the elements “exclude” (66), to exclude the selected foods; the “Continue shopping” element (58), to back to select new items; and the “Buy” element (57) to complete the purchase of the order;
after the order purchase is completed (57), send and register the OP in an order list (LOP) in the RTDB database.

31. A device to order food for restaurant characterized by comprise: a display, at least one processor, and a memory containing instructions, which when executed by the processor, causes the processor to perform the steps of the method defined in claim 30.
